(19) United States
(12) Patent Application Publication
(10) Pub. No.: US 2015/0313786 A1
(43) Pub. Date: Nov. 5, 2015

(54) WALKING ASSISTANCE DEVICE

(71) Applicant: NATIONAL UNIVERSITY CORPORATION NAGOYA INSTITUTE OF TECHNOLOGY, Nagoya-shi, Aichi (JP)

(72) Inventor: Akihito SANO, Nagoya-shi, Aichi (JP)

(21) Appl. No.: 14/651,369

(22) PCT Filed: Dec. 12, 2013
(86) PCT No.: PCT/JP2013/083370

§ 371 Date: Jun. 11, 2015

(30) Foreign Application Priority Data
Dec. 14, 2012 (JP) 2012-273612
Jul. 19, 2013 (JP) 2013-150182

(51) Int. Cl. A61H 3/00; A61H 1/02

(52) U.S. Cl. CPC A61H 3/00; A61H 1/0255; A61H 2003/007; A61H 2201/1215; A61H 2201/163; A61H 2201/1642; A61H 2201/1676; A61H 2201/1671

(57) ABSTRACT

A walking assistance device includes a waist wearing belt, a thigh link portion, a lower leg link portion, a lower leg wearing portion mounted on the lower leg link portion, a waist joint portion configured to hold an upper end portion of the thigh link portion so that the thigh link portion swings and the waist joint portion being mounted on the waist wearing belt, and a knee joint portion configured to connect the thigh link portion and the lower leg link portion so that the thigh link portion and the lower leg link portion swing. The thigh link portion and the lower leg link portion have rigidity that is greater in the front-rear direction and an up-down direction than in a right-left direction so as to be elastically twisted around an axis along an elongated direction.

### TECHNICAL FIELD

The present invention relates to a walking assistance device that is put on a person's leg to assist walking.

### BACKGROUND ART

As is disclosed in Patent Document 1, a walking assistance device that is put on a person's leg to assist walking has been known. Such a walking assistance device is performed based on the principle of passive walking and is developed by the inventor of the present application. The passive walking is closest to the persons' natural walking motion and walking assistance devices using the passive walking motion are especially attracting attention.

Other type of a walking assistance device including an actuator such as an electric motor is described in patent Document 2. Unlike such a type of the walking assistance device, the above-described walking assistance device does not require an actuator such as an electric motor. The walking assistance device using the principle of passive walking described in patent Document 1 is configured as follows. Motion of the leg (a normal leg) that does not wear the walking assistance device is transferred to the walking assistance device via a user's (a wearer's) hip (pelvis) so that the walking assistance device is operated naturally to assist the user's walking motion. Therefore, such a walking assistance device is reduced in weight and cost and it is expected to reduce a physical burden and a financial burden for the users.

### RELATED ART DOCUMENT

### Patent Document

Patent Document 1: International Publication No. 2012/002078

Japanese Unexamined Patent Application Publication No. 2012-50718

### Problem to be Solved by the Invention

Improvement of walking assistance performances of the walking assistance device using the passive walking motion has been recently demanded.

### DISCLOSURE OF THE PRESENT INVENTION

An object of the technology described herein is to provide a technology for further improving various performances of the walking assistance device using the passive walking motion such as walking assistance performances.

### Means for Solving the Problem

A walking assistance device according to the present invention is to be put on a leg of a user to assist walking of the user, and the walking assistance device includes a waist wearing belt including a pad member to be put on a waist side portion of the user, the waist wearing belt to be put around a waist of the user, a thigh link portion having an elongated shape and to be arranged on a side of a thigh of the user, a lower leg link portion having an elongated shape and to be arranged on a side of a lower leg of the user, a lower leg wearing portion to be put on a lower leg of the user and mounted on the lower leg link portion, a waist joint portion configured to hold an upper end portion of the thigh link portion so that the thigh link portion swings in a front-rear direction of the user, the waist joint portion being mounted on the pad member of the waist wearing belt, and a knee joint portion configured to hold a lower end portion of the thigh link portion and an upper end portion of the lower leg link portion and configured to connect the thigh link portion and the lower leg link portion so that the thigh link portion and the lower leg link portion swing, respectively. The thigh link portion and the lower leg link portion have rigidity that is greater in the front-rear direction and an up-down direction than in a right-left direction so as to be elastically twisted around an axis along an elongated direction of the thigh link portion and the lower leg link portion. In the walking assistance device, provided with the above configurations, the thigh link portion and the lower leg link portion have rigidity that is greater in the front-rear direction and an up-down direction than in a right-left direction. Therefore, if a twisting force to twist about an axial line (rotary axis) along the elongated direction is applied to the link portions, the link portions are elastically deformed easily so as to be twisted. Therefore, a user who is wearing the walking assistance device can change his/her direction with twisting his/her waist in a relatively small space.

In the walking assistance device, each of the thigh link portion and the lower ling portion may include a pair of tubular portions and a plate-like connection portion. The pair of tubular portions may be arranged parallel to each other with having a distance therebetween and each of the tubular portions may have a space therein, and the connection portion may be provided between the tubular portions to connect the tubular portions. In the walking assistance device, each of the thigh link portion and the lower ling portion includes a pair of tubular portions and the plate-like connection portion. The pair of tubular portions is arranged parallel to each other with having a distance therebetween and each of the tubular portions has a space therein, and the connection portion is provided between the tubular portions to connect the tubular portions. Therefore, the walking assistance device is reduced in weight thereof.

In the walking assistance device, the thigh link portion and the lower leg link portion may be extendable in the elongated direction. The longitudinal lengths of the thigh link portion and the lower leg link portion are adjusted, and the size of the walking assistance device is adjusted according to the users' build.

In the walking assistance device, the waist joint portion may hold the upper end portion of the thigh link portion so as to be removed therefrom, and the knee joint portion may hold the lower end portion of the thigh link portion and the upper end portion of the lower leg link portion so as to be removed therefrom. With the above configurations of the waist joint portion and he knee joint portion, the thigh link portion is replaced with another one and the lower leg link portion is replaced with another one.

In the walking assistance device, the thigh link portion may be selected from a thigh link portion group including a plurality kinds of thigh link portions having different conditions such as various elongated lengths, and the lower leg link portion may be selected from a lower leg link portion group including a plurality kinds of lower leg link portions having different conditions such as various elongated lengths. In the walking assistance device, the thigh link portion and the lower leg link portion are selected from various kinds of link portions, respectively. Therefore, the lengths of the thigh link portion and the lower leg link portion are appropriately determined according to a user's request (such as a user's body size).

In the walking assistance device, the lower leg wearing portion may be selected from a lower leg wearing portion group including plurality kinds of lower link wearing portions having different conditions such as various circumferential lengths. In the walking assistance device, the lower leg wearing portion is selected from a lower leg wearing portion group including plurality kinds of lower link wearing portions having different conditions such as various circumferential lengths. Therefore, the circumferential length of the lower leg wearing portion is appropriately determined according to a user's request (such as a user's body size).

The walking assistance device may further include a weight that is detachably mounted on the thigh link portion and/or the lower leg link portion. With such a configuration of the walking assistance device, the swing patterns of the thigh link portion and the lower leg link portion are altered.

In the walking assistance device, the weight may be selected from a group of various kinds of weights having various weights. The weight is selected from a group of various kinds of weights. Therefore, the swing patterns of the thigh link portion and the lower leg link portion are altered according to a user's request.

In the walking assistance device, each of the thigh link portion and the lower leg link portion may include a pair of elongated plate-like processed components that are connected together to be opposed to each other. In the walking assistance device, each of the thigh link portion and the lower leg link portion has the above configuration. Therefore, the rigidity of the thigh link portion is maintained with the thigh link portion and the lower leg link portion being deformable in the twisting direction.

In the walking assistance device, the waist joint portion may include a waist shaft, a holder where one end of the waist shaft is fixed and that holds the upper end portion of the thigh link portion, a main body portion connected to the holder and configured to swing the thigh link portion around the waist shaft in a front-rear direction, a rotary plate supported on the waist shaft to be rotatable around the waist shaft and fixed to the main body portion, and amount plate fixed to the rotary plate to be rotatable with the rotary plate and mounted on the waist wearing belt via the pad member. The walking assistance device may further include a torque generator. The torque generator may include a compression spring, a determination portion being in contact with one end of the compression spring and configured to determine a position of the one end, a displacement portion being in contact with another end of the compression spring and configured to displace according to expansion and contraction of the compression spring, a cam follower connected to the displacement portion, and a cam portion having an outer surface configured to push the cam follower to compress the compression spring and having distances from the waist shaft so as to change along a circumferential direction, the cam portion included on a peripheral edge portion of the rotary plate. With the above configuration of the walking assistance device, the number of components included in the torque generator is decreased and the torque generator is decreased in size and thickness.

In the walking assistance device, each of the thigh link portion and the lower leg link portion may be configured to be elastically twisted around a shaft along the elongated direction within an angle range of from +70° to −70°. If the thigh link portion and the lower leg link portion are elastically twisted in the above range, the thigh link portion and the lower leg link portion are effectively twisted and the twisted link portions easily recover original shapes during the user's walking. Further, the thigh link portion and the lower leg link portion having the above properties do not restrict the walking motion of the user wearing the walking assistance device including turning around but correct the user's walking motion.

### Advantageous Effect of the Invention

According to the technology disclosed herein, various performances of the walking assistance device using the passive walking motion such as walking assistance performances are improved.

### BRIEF DESCRIPTION OF THE DRAWINGS

FIG. 1 is a side view of a walking assistance device according to a first embodiment.

FIG. 2 is a view of a waist wearing belt included in the walking assistance device.

FIG. 3 is a view of the walking assistance device that a user wears.

FIG. 4 is a side view of a thigh link portion.

FIG. 5 is a cross-sectional view taken along line A-A′ in FIG. 4.

FIG. 6 is an inner side view of a waist joint portion.

FIG. 7 is a cross-sectional view taken along line C-C′ in FIG. 6.

FIG. 8 is a cross-sectional view of a knee joint portion.

FIG. 9 is an enlarged rear view of a thigh contact portion.

FIG. 10 is a schematic view of the walking assistance device that is worn by a user and the user walks.

FIG. 11 is a graph illustrating torque characteristics of a torque generator.

FIG. 12 is a graph illustrating a relationship between twisting angles θ (°) of a hollow leg member and twisting torques τ (Nm).

FIG. 13 is an enlarged rear view of a thigh contact portion of a walking assistance device according to a second embodiment.

FIG. 14 is a front view of a lower leg wearing portion used in a walking assistance device according to a third embodiment.

FIG. 15 is an upper view of the lower leg wearing portion used in the walking assistance device according to the third embodiment.

FIG. 16 is a perspective view of a cam adjusting device used in a walking assistance device according to a fourth embodiment.

FIG. 17 is an inner side view of the cam adjusting device used in the walking assistance device according to the fourth embodiment.

FIG. 18 is a side view of a walking assistance device according to a fifth embodiment.

FIG. 19 is a side view of a thigh link portion according to the fifth embodiment.

FIG. 20 is an exploded perspective view of a portion of the walking assistance device according to the fifth embodiment near a knee joint portion.

FIG. 21 is a side view of a walk assistance device having a weight.

FIG. 22 is an enlarged view of the weight put on the thigh link portion.

FIG. 23 is a cross-sectional view taken along line C-C′ in FIG. 22.

FIG. 24 is an explanation diagram of simulation of a walking assistance device of a double link portions model.

FIG. 25 is a graph illustrating changes over time of angles (absolute angles) θ10 between the thigh link portion that swings about a waist shaft and a vertical line passing through a center of a knee shaft and changes over time of angles (relative angles) θ20 between the thigh link portion and the lower leg portion that swing about the knee shaft.

FIG. 26 is a diagram illustrating a walking cycle.

FIG. 27 is a graph illustrating changes over time of the angles θ10 and the angles θ20 in the walking assistance device (with and without weight).

FIG. 28 is a cross-sectional view of a thigh link portion according to a modified embodiment.

FIG. 29 is a cross-sectional view of a thigh link portion according to another modified embodiment.

FIG. 30 is a cross-sectional view of a thigh link portion according to another different modified embodiment.

FIG. 31 is a view of a walking assistance device according to another embodiment.

FIG. 32 is a view of a waist wearing belt of a modified embodiment.

FIG. 33 is view of a mount plate of a modified embodiment.

FIG. 34 is a view of the walking assistance devices that are put on two legs.

### MODES FOR CARRYING OUT THE INVENTION

### First Embodiment

### (Walking Assistance Device 1)

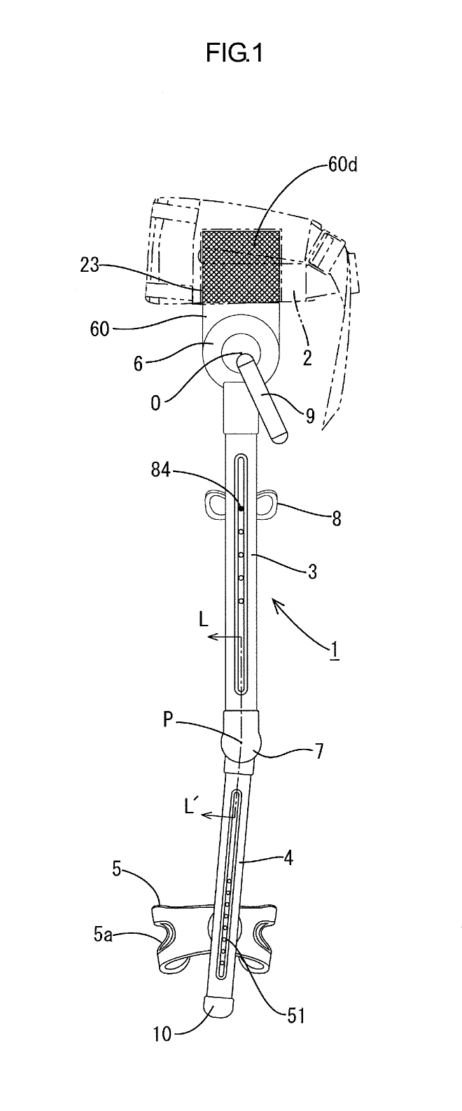

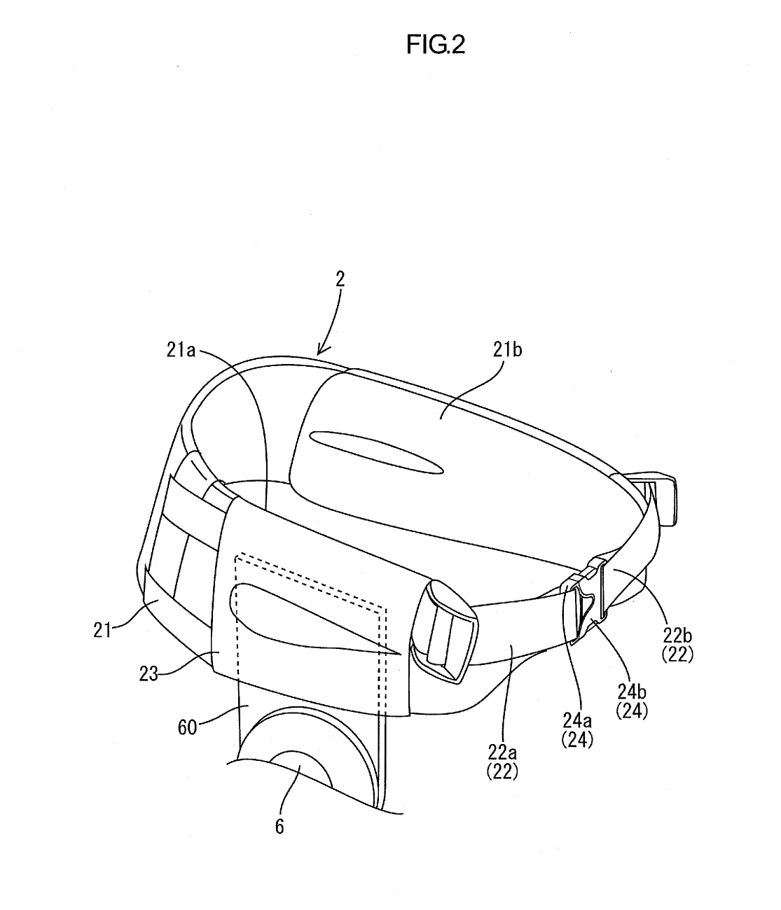

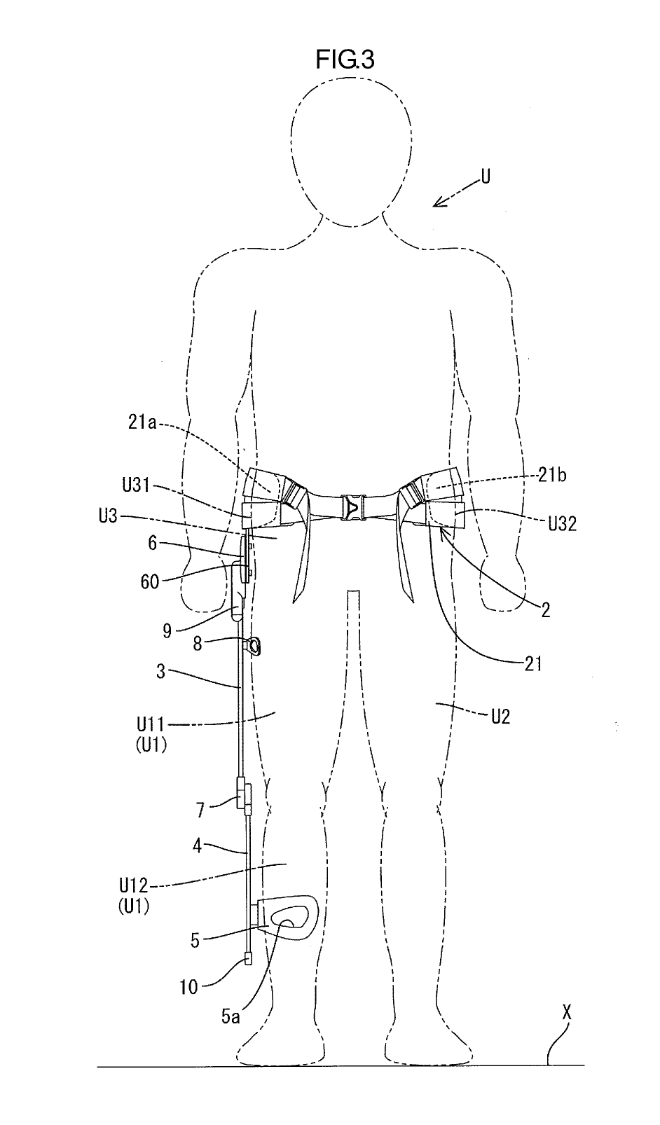

A walking assistance device 1 according to one embodiment of the present invention will be described with reference to FIGS. 1 to 11. FIG. 1 is a side view of the walking assistance device 1 according to a first embodiment. FIG. 2 is a (perspective) view of a waist wearing belt 2 included in the walking assistance device 1. FIG. 3 is a view of the walking assistance device 1 that a user U wears. The walking assistance device 1 of this embodiment is a passive walking type and mainly includes a waist wearing belt 2, a thigh link portion 3, a lower leg portion 4, a lower leg wearing portion, a waist joint portion 6, a knee joint portion 7, a thigh contact portion 8, and a torque generator 9. The walking assistance device 1 of this embodiment is for a right leg and put on a right leg U1 of a user U. The walking assistance device 1 for right leg is used for a user U who has an affected right leg U1 and a normal left leg U2. In another embodiment, the walking assistance device 1 for right leg may be put on a right leg of a user U who has a normal right leg and an affected left leg. In FIG. 1, a right side is a front side, a left side is a rear side, and an upper side and a lower side are above and below, respectively. In FIG. 3, a front side on a sheet is frontward, a rear side on a sheet is rearward, and an upper side and a lower side are above and below, respectively.

### (Waist Wearing Belt 2)

The waist wearing belt 2 is used to fix a link mechanism portion of the walking assistance device 1 to the user U and is put around the user's waist U3 to be put on the user U. The waist wearing belt 2 includes a main body 21 having a substantially flat arched shape and an adjuster 22 that adjusts a tightening degree of the waist wearing belt 2. The main body 21 is fit to the rear side of the waist U3 and right and left sides (hip side portions) of the waist U3. The adjuster 22 is provided to connect front ends of the right and left side portions of the main body 21. The main body 21 includes a pad member 21a that is made of resin closed-cell foam and has cushioning properties. The pad member 21a is provided on an inner portion of the main body that is put on a right waist portion U31 of the waist U3. A pad member 21b having cushioning properties is provided on an inner portion of the main body that is put on a left waist portion U32 of the waist U3. When the user U wears the waist wearing belt 2, the pad member 21a is in closely contact with the right waist portion U31 and the pad member 21b is in closely contact with the left waist portion U32. The right pad member 21a is opposite the left pad member 21b (left waist portion U32) with holding the waist U3 (the pelvis) therebetween.

The main body 21 includes therein a flat core made of resin. Therefore, the main body 21 supports the pad members 21a, 21b from an inner side thereof. The main body 21 has flexibility and is deformable so that the front end portions thereof on the right and left sides are close to or away from each other. The main body 21 includes a receiver portion 23 on an outer side with respect to the right pad member 21a and the receiver portion 23 has a pocket-like shape that is open downwardly. The receiver portion 23 receives therein an upper end portion of a mount plate 60 that is included in the waist joint portion 6 of the walking assistance device 1. The mount plate 60 is rotatable (swings) with respect to a waist shaft 61 of the waist joint portion 6 as will be described later. The mount plate 60 has a hook-and-loop fastener portion 60d on at least an outer surface (a surface facing the front side on the sheet of FIG. 1) in the surface of the upper end portion thereof. The receiver portion 23 has another hook-and-loop fastener portion (not illustrated) that is paired with the hook-and-loop fastener portion 60d to be attached thereto and detached therefrom. The other hook-and-loop fastener portion is provided inside (on an inner side of) the receiver portion 23. The upper end portion of the mount plate 60 is in the receiver portion 23 and the mount plate 60 is attached to the waist wearing belt 2 with adhesive force of the hook-and-loop fastener portions. The mount portion 60 whose upper end portion is in the receiver portion 23 is opposite the pad member 21a of the waist wearing belt 2. Namely, the pad member 21a and the upper end portion of the mount plate 60 overlap each other.

The adjuster 22 includes a right belt portion 22a and a left belt portion 22b. The right belt portion 22a is elongated on a right-side front end portion of the main body 21 and the left belt portion 22b is elongated on a left-side front end portion of the main body 21. The right belt portion 22a and the left belt portion 22b are attached to the respective front end portions of the main body 21 so as to adjust lengths thereof. The right belt portion 22a and the left belt portion 22b have connector portions 24 (24a, 24b), respectively, that are detachably connected to each other.

The waist wearing belt 2 including the mount plate 60 in the receiver portion 23 receives the motion (force) of the left leg (normal leg) U2 without wearing the walking assistance device 1 using mainly the pad member 21a. The waist wearing belt 2 transfers the received motion (force) to the waist joint portion 6 and the thigh link portion 3 via the mount plate 60. The pad member 21a is made of elastic material having cushioning properties and is elastically deformed to follow the surface shape of the waist U3 (the waist side portion U31). The pad member 21a has effective strength and following capability (elasticity). Therefore, a gap is less likely to be generated between the pad member 21a and the waist side portion U31 and the force is surely transferred to the thigh link portion 3 and other portions of the walking assistance device 1. Conditions of the pad member 21a such as a size, strength and elasticity (cushioning properties) are effectively determined with considering a size and a shape of the waist side portion U31 of the user U.

### (Thigh Link Portion 3)

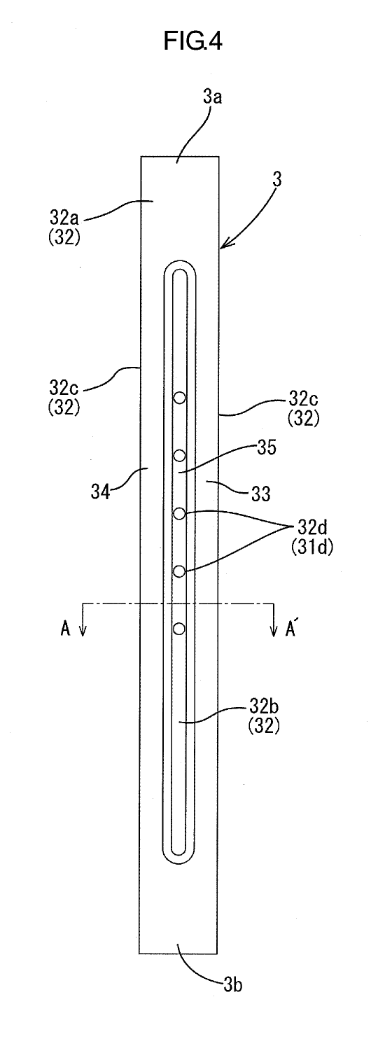

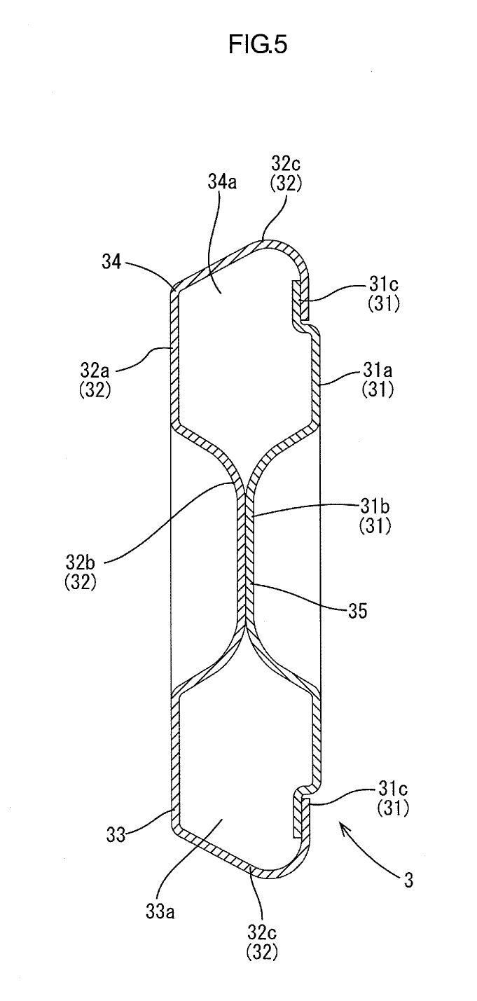

FIG. 4 is aside view of the thigh link portion 3. The thigh link portion 3 is mainly arranged on a side (an outer side) of the thigh U11 of the right leg U1 (refer to FIG. 3), and has an elongated column-shaped (elongated) outer shape as a whole. The thigh link portion 3 is made of a metal plate (a metal plate member) such as an electro galvanized steel sheet (SECC) that is processed into a certain shape. FIG. 5 is a cross-sectional view taken along line A-A′ in FIG. 4. As illustrated in FIG. 5, the thigh link portion 3 includes two elongated components that are fitted to (overlap) each other to face each other and form a tubular shape. One of the two components (processed components) constituting the thigh link portion 3 is a thigh inner member 31 that is provided adjacent to the thigh U11 and another one of the two components is a thigh outer member 32 that is provided on an outer side with respect to the thigh inner member 31 to be opposite the thigh inner member 31. In this embodiment, each of the metal plates (the metal plate member) used for the thigh inner member 31 and the thigh outer member 32 has a thickness of 0.4 mm and also has effective strength and flexibility so as to exert a flexible force when it is finally deformed to have a shape of the thigh link portion 3. In FIG. 5, the thigh inner member 31 is on the right side and the thigh outer member 32 is on the left side.

The thigh inner member 31 mainly includes an inner main body 31a, an inner projection portion (a first inner projection portion) 31b, and an inner fitting portions 31c, 31c. The inner main body 31a is a substantially elongated rectangular plate. The inner projection portion 31b is in a middle portion of the inner main body 31a and projected from the thigh U11 side toward the thigh outer member 32. The inner projection portion 31b is in contact with the thigh outer member 32. The inner fitting portions 31c, 31c are processed to be recessed from the thigh U11 side toward the thigh outer member 32 and form steps. The inner fitting portions 31c, 31c are fitted to long-side ends of the thigh outer member 32. The inner projection portion 31b extends straight in the longitudinal direction of the thigh inner member 31 (the inner main body 31a). If the thigh inner member 31 is seen from the thigh U11 side, the inner projection portion 31b has a shape of an elongated recessed groove. The inner projection portion 31b has through holes 31d at intervals in a line. The thigh inner member 31 is formed from the elongated rectangular metal plate member with a pressless forming method (registered trademark) that is one of drawing processing.

The thigh outer member 32 mainly includes an outer main body 32a, an outer projection portion (a first outer projection portion) 32b, and an outer fitting portions 32c, 32c. The outer main body 32a is a substantially elongated rectangular plate. The outer projection portion 32b is in a middle portion of the outer main body 32a and projected from the outside toward the thigh inner member 31 (the thigh U11). The outer projection portion 32b is in contact with the thigh inner member 31. The outer fitting portions 32c, 32c are formed by bending the long-side end portions of the outer main body 32a toward the thigh inner member 31. The outer fitting portions 32c, 32c are overlapped with and fitted to the inner fitting portions 31c, 31c. The thigh outer member 32 has a length (in the longitudinal direction thereof) that is equal to a length (in the longitudinal direction) of the thigh inner member 31. The outer projection portion 32b extends straight in the longitudinal direction of the thigh outer member 32 (the outer main body 32a). If the thigh outer member 32 is seen from the outside, the outer projection portion 32b has a shape of an elongated recessed groove. The outer projection portion 32b has through holes 32d at intervals in a line similarly to the inner projection portion 31b. The through holes 32d formed in the outer projection portion 32b overlap the through holes 31d formed in the inner projection portion 31b, respectively. They are used to fix the thigh contact portion 8. Each through hole 32d has a size equal to that of each through hole 31d. The thigh outer member 32 is formed from a rectangular metal plate member that is wider (greater short-side length) than the thigh inner member 31 with the pressless forming method (registered trademark).

As illustrated in FIG. 5, the outer projection portion 32b of the thigh outer member 32 included in the thigh link portion 3 is in closely contact with the inner projection portion 31b of the thigh inner member 31. The outer fitting portions 32c, 32c of the thigh outer member 32 are fitted to the respective inner fitting portions 31c, 31c so as to push the thigh inner member 31 toward the outer main body 32a. Accordingly, the thigh outer member 32 is fitted to hold the thigh inner member 31. A contact portion of the inner projection portion 31b and the outer projection portion 32b that are in contact with each other and fitting portions of the respective inner fitting portions 31c, 31c and the respective outer fitting portions 32c, 32c that are fitted together form spaces therebetween along the longitudinal side of the thigh link portion 3. When the thigh inner member 31 and the thigh outer member 32 are fitted together, the thigh inner member 31 is slid along the long side from one end toward another end of the thigh outer member 32 and inserted into the spaces inside the thigh outer member 32.

The thigh link portion 3 as a whole is constituted by the two elongated processed components (the thigh inner member 31 and the thigh outer member 32) that are fitted together to form a tubular (columnar) shape having a space therein. The inner projection portion 31b and the outer projection portion 32b are provided as reinforcing members that improve strength of the thigh link portion 3. Therefore, the thigh link portion 3 has enough rigidity against the force applied in the longitudinal direction thereof (for example, a force acting on the thigh link portion 3 to pull it in the longitudinal direction, a force acting on the thigh link portion 3 to compress it in the longitudinal direction) in use of the walking assistance device 1. Therefore, the thigh link portion 3 is less likely to be broken or bent. Even if a force is applied to the thigh link portion 3 so that two end portions in the longitudinal direction thereof are getting closer to each other in use of the walking assistance device 1, the thigh link portion 3 having rigidity is less likely to be bent. The thigh link portion 3 has sufficient rigidity for the walking assistance device 1 in a direction of a torque acting on the thigh link portion 3 around the waist shaft 61 and in a direction of a torque acting on the thigh link portion 3 around the knee shaft 71.

The thigh link portion 3 of this embodiment is slightly deformed to be twisted if the thigh link portion 3 receives a twisting force around a longitudinal shaft line (a rotary shaft) thereof. The thigh inner member 31 and the thigh outer member 32 constituting the thigh link portion 3 are formed of the processed metal plate members having flexibility and are not fixed to each other firmly. Therefore, the thigh link portion 3 is elastically deformed as a whole in the twisting direction when the thigh link portion 3 is twisted. For example, the inner fitting portion 31c of the thigh inner member 31 and the outer fitting portion 32c of the thigh outer member 32 are fitted together with overlapped but are not fixed to each other firmly.

The rigidity of the thigh link portion 3 and the elastic deformation degree of the thigh link portion 3 in the twisting direction are adjusted by altering various conditions such as a plate thickness or a kind of metal of the components 31, 32 of the thigh link portion 3, a size or a shape of the outer projection portion 32b of the thigh outer member 32 and the inner projection portion 31b of the thigh inner member 31, a size of the inner space of the thigh link portion 3, and a fitting force between the inner fitting portions 31c, 31c and the outer fitting portions 32c, 32c. For example, the components 31, 32 made of stainless material having great strength instead of SECC increases strength of the thigh link portion 3. If (a size of) the inner space of the thigh link portion 3 is increased, the strength of the thigh link portion 3 in an axial direction thereof is increased and the second moment of area is also increased. Accordingly, bending strength is increased. However, this increases the twisting strength. Therefore, the conditions are necessary to be set according to the user's leg strength.

One end portion (an upper end portion) 3a of the thigh link portion 3 is connected to the waist joint portion 6 and another end portion (a lower end portion) 3b is connected to the knee joint portion 7, as will be described later.

The thigh link portion 3 has a length (in the longitudinal direction thereof) that is set as follows. In condition that the upper end portion 3a is connected to the waist joint portion 6 and the lower end portion 3b is connected to the knee joint portion 7, when a center of the waist shaft 61 of the waist joint portion 6 is slightly above the greater trochanter of the user's waist side portion U31 (for example, several centimeters above the greater trochanter or at the position of the user's hip joint), a center of the knee shaft 71 of the knee joint portion 7 is slightly above the user's knee joint. The center of the knee shaft 71 of the knee joint portion 7 may be set in any position within a range from the upper end to the lower end of the user's knee joint portion (that is, a range of the knee joint portion). In this embodiment, the length of the thigh link portion 3 is set to 300 mm.

The thigh link portion 3 includes a pair of tubular portions 33, 34 and a connection portion 35 having a plate-like shape. The tubular portions 33, 34 are parallel to each other with a distance therebetween and include spaces 33a, 34a respectively. The connection portion 35 is between the tubular portions 33, 34 and connects the tubular portions 33, 34. The tubular portions 33, 34 are constituted by the thigh inner member 31 and the thigh outer member 32. The connection portion 35 is also constituted by the thigh inner member 31 and the thigh outer member 32.

### (Lower Leg Link Portion 4)

A lower leg link portion 4 is mainly arranged on a side (an outer side) of a lower leg U12 of the right leg U1 (see FIG. 3). The lower leg link portion 4 has an outer appearance of an elongated columnar shape (an elongated shape) as a whole similarly to the thigh link portion 3. The lower leg link portion 4 has a length in a longitudinal direction thereof, a width (a length in a short-side direction), and a thickness each of which is slightly smaller than that of the thigh link portion 3. The lower leg link portion 4 is made of a metal plate (a metal plate member) such as an electro galvanized steel sheet (SECC) that is processed into a certain shape similarly to the thigh link portion 3. Specifically, the lower leg link portion 4 is formed by fitting (overlapping) two elongated components together so as to be opposed to each other to form a tubular shape.

The lower leg link portion 4 of this embodiment is slightly deformed to be twisted if the lower leg link portion 4 receives a twisting force around a longitudinal shaft line (a rotary shaft) thereof.

One end portion (an upper end portion) 4a of the lower leg link portion 4 is on the thigh link portion 3 side and is connected to the knee joint portion 7 as will be described later. Another end portion (a loser end portion) 4b of the lower leg link portion 4 is on a side of the user's ankle. As illustrated in FIGS. 1 and 2, a protection cap 10 is fitted to the lower end portion 4b. The protection cap 10 prevents the lower leg link portion 4 from bending.

The protection cap 10 is made of metal material such as aluminum or magnesium and the metal material is processed into a certain shape. The protection cap 10 has a fitting hole where the lower end portion 4b of the lower leg link portion 4 is fitted. The lower end portion 4b of the lower leg link portion 4 is fixed to the fitting hole with adhesive. The lower end portion 4b is fixed to the fitting hole and the lower end portion 4b of the lower leg link portion 4 is protected by the protection cap 10.

The length of the lower leg link portion 4 (in the longitudinal direction thereof) is smaller than the length of the thigh link portion 3 (in the longitudinal direction thereof). The lower leg link portion 4 has a length so that a lower leg wearing portion 5 (which will be described later) mounted on the lower leg link portion 4 is put on a lower leg U12 of the user U. In this embodiment, the length of the lower leg link portion 4 is 250 mm. In another embodiment, the length of the lower leg link portion 4 may be smaller. As illustrated in FIG. 3, in the walking assistance device 1 that is put on the user, the lower end portion 4b of the lower leg link portion 4 is above the user's ankle. As illustrated in FIG. 3, the lower leg link portion 4 is on an inner side with respect to the thigh link portion 3.

### (Lower Leg Wearing Portion 5)

As illustrated in FIGS. 1 and 3, a lower leg wearing portion (shin cuff) 5 is put on the lower leg U12 of the user's right leg U1 and has a substantially U shape as a whole so as to hold the lower leg U12 from the front and rear sides. The lower leg wearing portion 5 transfers (outputs) a motion of (a force from) the lower leg link portion 4 to the lower leg U12 of the user U. The lower leg wearing portion 5 has a shape of a figure of eight that is curved with a plan view from an outer side (a right side) where the lower leg link portion 4 is fixed. A front portion of the leg wearing portion 5 is curved rearward and a rear portion thereof is curved frontward. The lower leg wearing portion 5 has through holes 5a for decreasing a weight thereof and improving elasticity. The lower leg wearing portion 5 has a tapered shape from an upper portion toward a lower portion thereof. The lower leg wearing portion 5 has a gap between a front end portion and a rear end portion and the lower leg U12 is put in or removed from the lower leg wearing portion 5 through the gap. The lower leg wearing portion 5 is formed by processing synthetic resin into a certain shape and has effective strength and elasticity. Therefore, the lower leg wearing portion 5 is tightly fit to the lower leg 12 with slightly being expanded. If the lower leg wearing portion 5 is too large for the lower leg U12 or the lower leg wearing portion 5 is too flexible to be excessively expanded, the motion of the lower leg link portion 4 is not effectively transferred to the lower leg U12 via the lower leg wearing portion 5. Therefore, conditions of the lower leg wearing portion 5 such as a size, strength, elasticity are determined according to a size, a shape, and a position of the lower leg U12 of the user U. The lower leg wearing portion 5 is detachably fixed to an inner side surface of the lower leg link portion 4 with a screw-shaped fixing member 51. The screw-shaped fixing member 51 is inserted through through holes 42d, 41d formed in the lower leg link portion 4 to be fixed to the lower leg link portion 4. The positions of the through holes 42d, 41d in the lower leg link portion 4 may be altered to adjust the mount position of the lower leg wearing portion 5 in the height direction. A mounting angle at which the lower leg wearing portion 5 is mounted to the fixing member 51 may be altered in the front-rear direction to adjust inclination of the lower leg wearing portion 5 in the front-rear direction.

### (Waist Joint Portion 6)

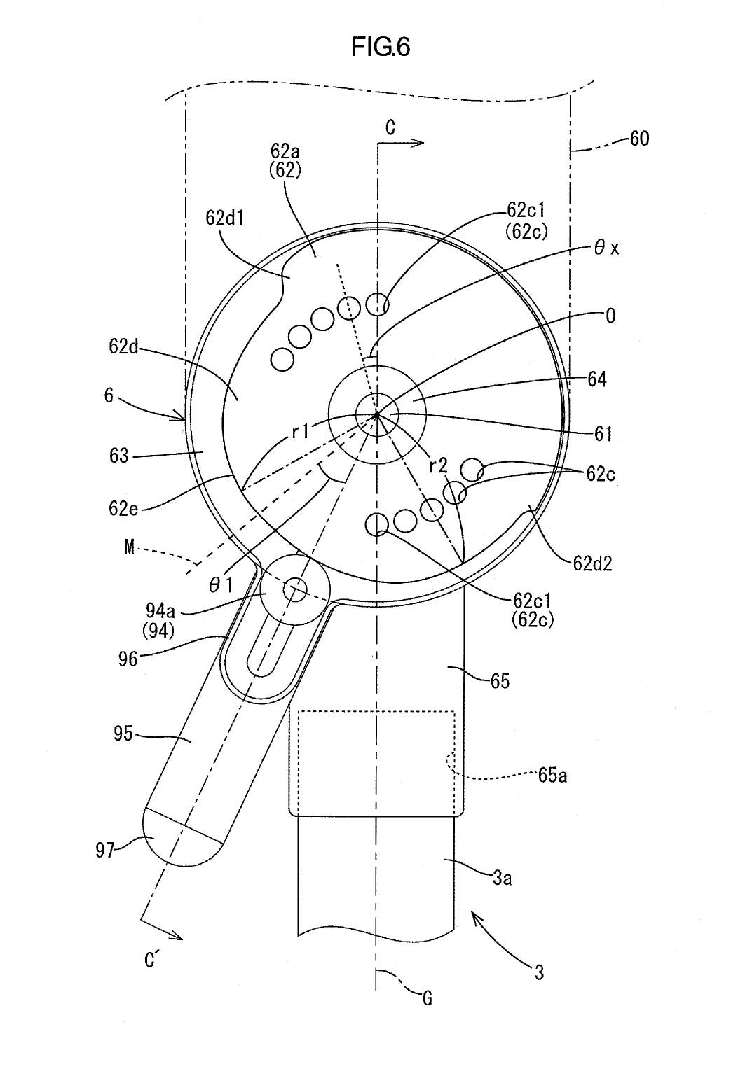

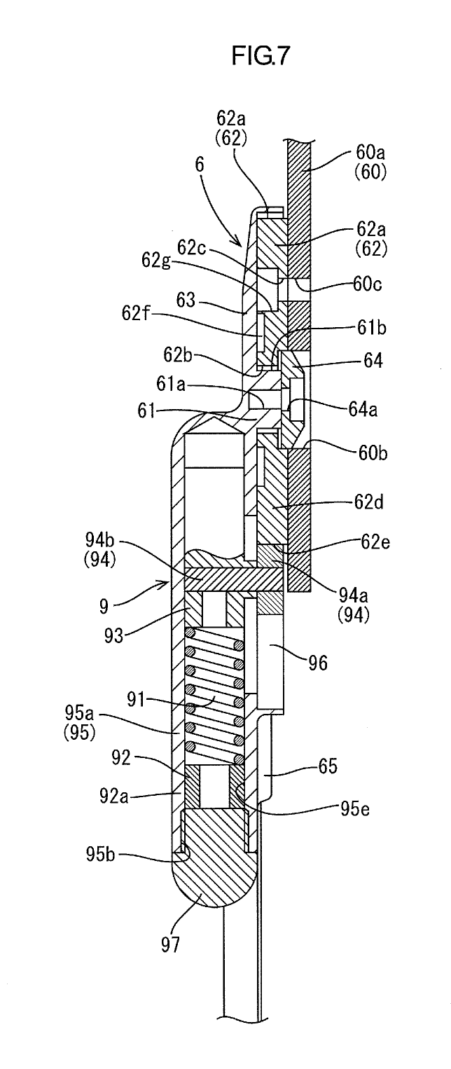

The waist joint portion 6 holds the upper end (the upper end portion 3a) of the thigh link portion 3 and the thigh link portion 3 is supported by the waist joint portion 6 to swing in the front-rear direction of the user U. The waist joint portion 6 is mounted on the waist wearing belt 2 to be opposite the pad member 21a. FIG. 6 is an inner side view of the waist joint portion 6. FIG. 7 is a cross-sectional view taken along line C-C′ in FIG. 6. A cross-sectional configuration of the vicinity of the waist joint portion 6 taken along line C-C′ including two lines crossing at a center 0 of the waist shaft 61 in FIG. 6 is illustrated in FIG. 7. As illustrated in FIGS. 6 and 7, the waist joint portion 6 includes the waist shaft 61 having a substantially cylindrical shape, a rotary plate 62, a housing (a main body) 63, a stopper 64, a holder 65, and a mount plate 60. The rotary plate 62 is rotatably supported on the waist shaft 61. One end of the waist shaft 61 is fixed to the housing 63 and the rotary plate 62 is arranged in the housing 63. The stopper 64 is fixed to another end of the waist shaft 61 and stops the rotary plate 62 supported on the waist shaft 61 from dropping off therefrom. The holder 65 is formed integrally with the housing 63 and holds the upper end portion 3a of the thigh link portion 3 to connect the waist joint portion 6 and the thigh link portion 3. The mount plate 60 is fixed to the rotary plate 62 so as to be rotatable with the rotary plate 62 and mounted on the waist wearing belt 2 to be opposite the pad member 21a. The components included in the waist joint portion 6 are made of metal material such as aluminum and magnesium and the metal material is processed into a certain shape with a known processing technology (such as means of cut machining). In other embodiments, the components of the waist joint portion 6 may be made of other material such as engineering plastic.

The waist shaft 61 has one end that is fixed to the housing 63 as described above. The housing (main body) 63 has a circular shallow bowl shape as a whole and the waist shaft 61 projects from a middle portion of an inner surface of the housing 63. The waist shaft 61 includes a resin layer 61b on a peripheral surface thereof to reduce friction against a peripheral surface of a shaft hole 62b of the rotary plate 62. As illustrated in FIG. 6, the rotary plate 62 has a substantially disk-like shape and made of metal material. The rotary plate 62 includes a disk-like shaped main body 62a, a shaft through hole 62b, and fixing through holes 62c, 62c. The main body 62a has the shaft through hole 62b in a middle portion thereof and the waist shaft 61 is inserted through the shaft through hole 62b. The disk-like main body 62a has at least a pair of fixing through holes 62c, 62c to be opposite each other with having the shaft hole 62b therebetween. As illustrated in FIG. 6, five pairs of the fixing through holes 62c (10 in total) are formed in the main body 62a of the rotary plate 62. In this embodiment, the two adjacent fixing through holes 62c, 62c that are along the periphery of the rotary plate 62 are formed so that an angle θx formed between a line connecting the center O and a center of one of the two adjacent fixing through holes 62c and a line connecting the center O and a center of another one of the two adjacent fixing through holes 62c is 15°. The fixing through holes 62c are used to fix the mount plate 60 to the rotary plate 62 with the screw-shaped fixing member (not illustrated).

The disk-like shaped stopper 64 is attached to the other end of the waist shaft 61 and the disk-like shaped stopper 64 has a diameter greater than that of the waist shaft 61. The waist shaft 61 and the stopper 64 have screw holes 61a, 64a in central portions thereof, respectively, and screw-shaped fixing members (not illustrated) are inserted in the respective screw holes 61a, 64a. The screw-shaped fixing members (not illustrated) are inserted in the respective screw holes 61a, 64a and tightened so that the stopper 64 is fixed to the other end of the waist shaft 61. The stopper 64 stops the rotary plate 62 that is supported on the waist shaft 61 from dropping off from the waist shaft 61 unnecessarily during usage of the walking assistance device 1.

The mount plate 60 will be described. The upper end portion of the mount plate 60 is mounted on the waist wearing belt 2, as described before. The lower end portion of the mount plate 60 is fixed to the rotary plate 62 that is rotatably supported on the waist shaft 61. The mount plate 60 has a substantially rectangular shape as a whole and the lower end portion thereof has a shape following an arch-shaped peripheral edge of the housing 63 (arched shape). The mount plate 60 is made of plastic material or metal material. In this embodiment, the mount plate 60 is made of resin material such as acrylic, high-molecular-weight polyethylene, or polycarbonate. The mount plate 60 includes a main body 60a having a plate-like shape, a through hole portion 60b, and a fixing hole 60c. The stopper 64 fixed to the waist shaft 61 can be visible through the through hole portion 60b. The mount plate 60 is fixed to the rotary plate 62 using the fixing hole 60c.

In fixing the mount plate 60 to the rotary plate 62, the mount plate 60 is overlapped with the rotary plate 62 so that the fixing through hole 60c of the mount plate 60 overlaps the fixing through hole 62c of the rotary plate 62. As is not illustrated in FIG. 7, the mount plate 60 has at least a pair of fixing through holes 60c (two fixing through holes 60c) that are opposite each other with having the through hole portion 60b therebetween. In this embodiment, the mount plate 60 is overlapped with the rotary plate 62 so that the two fixing through holes 60c of the mount plate 60 overlap respective fixing through holes 62c1, 62c1 in pair among the fixing holes 62c of the rotary plate 62 illustrated in FIG. 6.

A bolt-shaped fixing member (not illustrated) is inserted in the fixing through hole 62c (62c1) and the fixing through hole 60c that are overlapped with each other. The rotary plate 62 has the fixing through holes 62c and nut-shaped fixing members (not illustrated) are arranged in spaces 62g in the respective fixing through holes 62c. Therefore, after the nut-shaped fixing member is arranged in the space 62g, the bolt-shaped fixing member is inserted to the fixing through hole 60c of the mount plate 60 and the fixing through hole 62c of the rotary plate 62 to be screwed into the nut-shaped fixing member. Accordingly, the mount plate 60 is fixed to the rotary plate 62. The mount plate 60 is mounted on the waist shaft 61 so as to rotate (swing) in the front-rear direction similarly to the rotary plate 62. The rotary plate 62 includes a cam portion 62d that constitutes a torque generator 9 as will be described later. The rotary plate 62 has a smoothing portion 62f on an outer surface (opposite the housing 63). The smoothing portion 62f has a ring shape surrounding the shaft hole 62b and is made of resin. The smoothing portion 62f reduces friction caused between the rotary plate 62 and the housing 63 and also reduces wearing of the rotary plate 62.

The holder 65 is formed integrally with the lower end portion of the housing (main body) 63. The holder 65 has a square tubular shape that is open downward as a whole. The holder 65 has an insertion hole 65a at a lower end thereof where the upper end portion 3a of the thigh link portion 3 is inserted. The upper end portion 3a of the thigh link portion 3 is fixed to the insertion hole 65a of the holder 65 with adhesive. Thus, the upper end portion 3a is fixed to the insertion hole 65a so that the holder 65 holds the thigh link portion 3.

As described above, the waist joint portion 6 that is mounted on the waist wearing belt 2 holds the thigh link portion 3 so that the thigh link portion 3 rotates (swings) about the waist shaft 61 in the front-rear direction.

### (Knee Joint Portion 7)

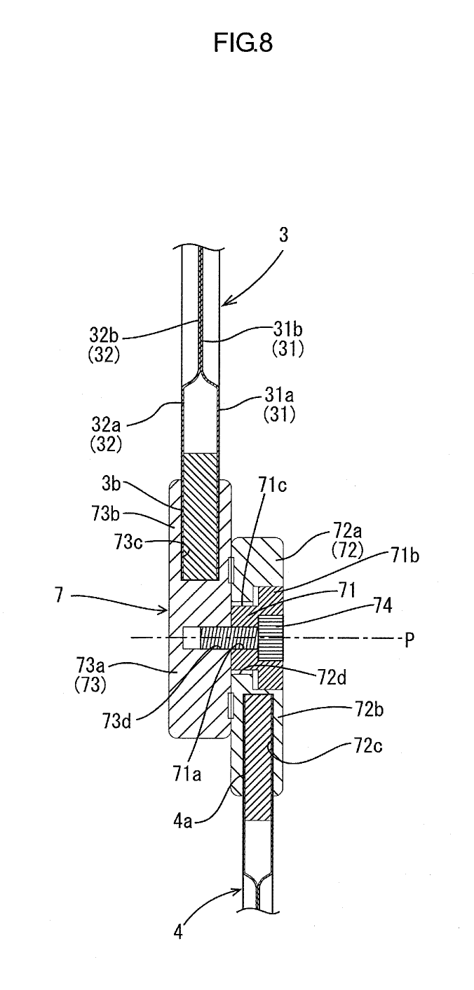

FIG. 8 is a cross-sectional view of the knee joint portion 7 taken along line L-L′ in FIG. 1. The knee joint portion 7 connects the thigh link portion 3 and the lower leg link portion 4 so as to rotate (swing), respectively. The knee joint portion 7 includes a knee shaft 71 having a substantially columnar shape, a lower leg side knee joint portion 72 that holds the upper end portion 4a of the lower leg link portion 4, a thigh side knee joint portion 73 that holds the lower end portion 3b of the thigh link portion 3, and a screw-shaped fixing member 74 that fixes the knee shaft 71 to the thigh side knee joint portion 73. The lower leg side knee joint portion 72 and the thigh side knee joint portion 73 overlap each other and rotate (swing) about the knee shaft 71, respectively. The lower leg side knee joint portion 72 and the thigh side knee joint portion 73 of this embodiment are formed by processing metal material such as aluminum into certain shapes with a known processing technology (such as means of cut machining).

As illustrated in FIG. 8, the knee shaft 71 has an insertion through hole 71a at a center thereof (on a shaft line P). A screw-shaped fixing member 74 is inserted through the insertion through hole 71a. The knee shaft 71 has one end that is on the thigh side knee joint portion 73 side and another end having a diameter greater than that of the one end. A greater diameter portion 71b that is the other end prevents the lower leg side knee joint portion 72 that is supported on the knee shaft 71 from dropping off from the knee shaft 71. The one end of the knee shaft 71 having a smaller diameter includes a resin layer 71c on a peripheral surface thereof to reduce occurrence of friction.

The lower leg side knee joint portion 72 includes a main body 72a and a holder portion 72b. The main body 72a mainly overlaps the thigh side knee joint portion 73 and has a substantially disk-like shape. The holder portion 72b is continuous from a lower end of the main body 72a and holds the upper end portion 4a of the lower leg link portion 4. The main body 72a has a shaft through hole 72d through which the knee shaft 71 is inserted. An inner diameter of the shaft through hole 72d is greater on an opposite side than on the thigh side knee joint portion 73 side. The greater diameter portion 71b of the knee shaft 71 is arranged in a greater inner diameter portion of the through hole 72d. The portion of the knee shaft 71 having a smaller diameter is arranged in a smaller inner diameter portion of the shaft through hole 72d that is on the thigh side knee joint portion 73 side.

The holder portion 72b has a square tubular shape that is open downward as a whole and is formed integrally with the main body 72a. The holder portion 72b has an insertion hole 72c on a lower end thereof and the upper end portion 4a of the lower leg link portion 4 is inserted in the insertion hole 72c. The upper end portion 4a of the lower leg link portion 4 is fixed to the insertion hole 72c of the holder portion 72b with adhesive. Thus, the upper end portion 4a is fixed to the insertion hole 72c so that the holder portion 72b of the lower leg side knee joint portion 72 holds the lower leg link portion 4.

The thigh side knee joint portion 73 includes a main body 73a and a holder portion 73b. The main body 73a mainly overlaps the lower leg side knee joint portion 72 and has a substantially disk-like shape. The holder portion 73b is continuous from an upper end of the main body 73a and holds the lower end portion 3b of the thigh link portion 3. The main body 73a has a shaft hole 73d having a bottom where a distal end portion of the screw-shaped knee shaft 71 is inserted and screwed into. The shaft hole 73d is on the shaft line P of the knee shaft 71.

The holder portion 73b has a square tubular shape that is open upward as a whole and is formed integrally with the main body 73a. The holder portion 73b has an insertion hole 73c on an upper end thereof and the lower end portion 3b of the thigh link portion 3 is inserted in the insertion hole 73c. The lower end portion 3b of the thigh link portion 3 is fixed to the insertion hole 73c of the holder portion 73b with adhesive. Thus, the lower end portion 3b is fixed to the insertion hole 73c so that the holder portion 73b of the thigh side knee joint portion 73 holds the thigh link portion 3.

As described before, the knee joint portion 7 connects the thigh link portion 3 and the lower leg link portion 4 via the knee shaft 71 (around the knee shaft 71) so as to rotate (swing) respectively. The knee joint portion 7 may include a resin smoothing portion on a portion thereof where the lower leg side knee joint portion 72 and the thigh side knee joint portion 73 are in contact with each other to reduce occurrence of friction therebetween and wearing.

### (Thigh Contact Portion 8)

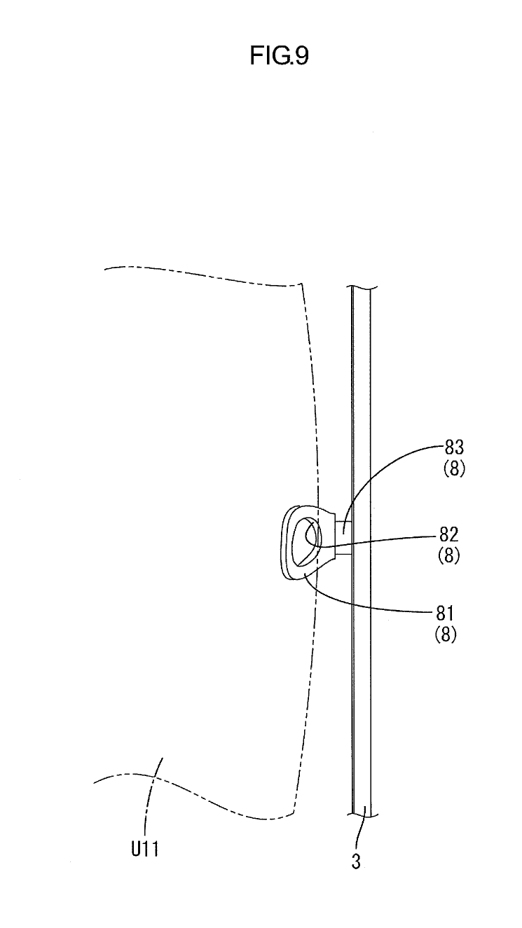

FIG. 9 is an enlarged rear view of the thigh contact portion 8. As illustrated in FIG. 3, the thigh contact portion 8 is put on a thigh U11 of a user's right leg U1 to support the thigh U11. The thigh contact portion 8 is smaller in size than the lower leg wearing portion 5 and has a flat shape extending in the front-rear direction. The thigh contact portion 8 is curved to follow a side surface shape of the thigh U11. The thigh contact portion 8 is formed by processing synthetic resin into a certain shape similarly to the lower leg wearing portion 5. The thigh contact portion 8 includes contact portions 81 and a fixing portion 83 that has a cylindrical shape. Each of the contact portions 81 has a curved flat shape and is put on the thigh U11. The fixing portion 83 projects from the contact portions 81 and is fixed to the main body 3c of the thigh link portion 3. Each contact portion 81 has a through hole 82 for reducing a weight of the thigh contact portion 8.

The thigh contact portion 8 is fixed to the thigh link portion 3 via the fixing portion 83 such that the contact portions 81 are put on the thigh U11 and arranged between the thigh link portion 3 and the thigh U11. The thigh link portion 3 has the through holes 32d, 31d and the screw-shaped fixing member 84 (see FIG. 1) is inserted through the through holes 32d, 31d and screwed into the fixing portion 83 of the thigh contact portion 8. Accordingly, the thigh contact portion 8 is fixed in a certain position of the thigh link portion 3. In this embodiment, the thigh contact portion 8 is mounted on the thigh link portion 3 so as to be put on a portion of the thigh U11 that is above a middle portion thereof with respect to the height dimension (the up-down direction). The thigh contact portion 8 is put on a substantially middle portion of the thigh U11 with respect to the front-rear direction. An angle between the contact portion 81 of the thigh contact portion 8 and the thigh link portion is adjusted by altering a fixing angle between the fixing portion 83 and the thigh link portion. In another embodiment, the thigh contact portion 8 may be mounted on the thigh link portion 3 to be put on a portion of the thigh U11 below the middle portion thereof, or the thigh contact portion 8 may be put on an outermost portion of the thigh U11. The thigh contact portion 8 may be mounted on any portion of the thigh link portion 3 as long as the thigh contact portion 8 is at least put on the thigh U11.

The user U who wears the walking assistance device 1 including the thigh contact portion 8 stably and easily keeps a standing posture when the user U stands up. The user U stably keeps a balanced posture (in the right-left direction) in one leg standing with the right leg U1 wearing the walking assistance device 1, because the right leg U1 is supported by the three points including the waist wearing belt 2, the lower leg wearing portion 5, and the thigh contact portion 8. The balanced posture of the right leg U1 in the right-left direction is stably kept when the right leg U1 functions as a support leg (a landing leg) during the user's walking with the walking assistance device 1. While the user U is walking, a force is likely to be transferred from the walking assistance device 1 to the right leg U1 via the lower leg wearing portion 5 and the thigh contact portion 8.

### (Torque Generator 9)

The torque generator 9 generates a joint torque around the waist shaft 61 using a cam-spring mechanism. As illustrated in FIGS. 6 and 7, the torque generator 9 mainly includes a compression spring 91, a determination portion 92, a displacement portion 93, a cam follower (a roller follower) 94, a cam portion 62d, a tubular housing portion 95, and a cam follower arrangement portion 96. The determination portion 92 has a columnar shape and is in contact with one end of the compression spring 91 to determine a position of the one end. The displacement portion 93 is in contact with another end of the compression spring 91 and displaced by the compression spring 91 that expands and contracts. The cam follower 94 is connected to the displacement portion 93. The cam portion 62d has an outer peripheral surface 62e that pushes the cam follower 94 so that the compression spring 91 is compressed. A distance from the waist shaft 61 to the outer peripheral surface 62e varies along the peripheral direction. The cam portion 62d is included in a part of a peripheral edge of the rotary plate 62. The determination portion 92, the compression spring 91, and the displacement portion 93 are arranged in the tubular housing portion 95. The cam follower arrangement portion 96 is connected to the tubular housing portion 95. The cam follower 94 moves in the direction in which the compression spring 91 expands and contracts and the cam follower 94 is arranged in the cam follower arrangement portion 96.

The compression spring 91 is a coiled spring having predetermined spring constant (a compression coil spring) and arranged in the tubular housing portion 95. The columnar determination portion 92 that is made of metal is arranged at one end of the compression spring 91 in the tubular housing portion 95. The determination portion 92 is arranged in the tubular housing portion 95 so as to be in contact with the one end of the compression spring 91. The determination portion 92 has a spirally grooved screw outer surface 92a. The tubular housing portion 95 has a spirally grooved screw inner surface 95e. The screw outer surface 92a and the screw inner surface 95e are screwed together so that the determination portion 92 is fixed within the tubular housing portion 95. The determination portion 92 has a straight slot groove (not illustrated) on an end surface thereof. A tool such as straight slot screwdriver is inserted in the groove to rotate the determination portion 92. Accordingly, the determination portion 92 is moved up or down within the tubular housing portion 95 to adjust the position of the end of the compression spring 91 (namely, a spring compression amount of the compression spring 91). A cover 97 is detachably put on one end portion (a distal end portion) of the tubular housing portion 95. The cover 97 covers an opening 95b at the distal end portion of the tubular housing portion 95 and has a screw outer surface that is fitted to the spirally grooved screw inner surface 95e. In adjusting the position of the determination portion 92 (namely, the position of the end of the compression spring 91), the cover 97 is removed from the tubular housing portion 95. After the adjustment, the cover 97 is attached to the tubular housing portion 95 to close the opening 95b. In the torque generator 9 included in the walking assistance device 1, the generated torque is necessary to be adjusted frequently. For example, a torque to be generated is necessary to be adjusted finely according to a user's condition (such as a functional recovery degree or a fatigue degree of the affected leg) or a place of walking (such as a flat ground or sloped ground). Therefore, as is described in this embodiment, the position of the determination portion 92 that determines the compression amount of the compression spring 91 is necessary to be adjusted with a configuration described above.

The displacement portion 93 is arranged on another end portion side (a basal end side) of the tubular housing portion 95 and is in contact with another end of the compression spring 91. The displacement portion 93 and the determination portion 92 hold the compression spring 91 therebetween. The displacement portion 93 is displaced in the expansion-contraction direction (along the axis of the tubular housing portion 95) within the tubular housing portion 95. The cam follower 94 having a roller portion 94a that is pushed against the outer surface 62e of the cam portion 62d is mounted on the displacement portion 93. The roller portion 94a is rotatably mounted on a shaft portion 94b that is fixed to the displacement portion 93. As the position of the roller portion 94a is pushed upward due to the shape of the outer surface 62e of the cam portion 62d, the cam follower 94 and the displacement portion 93 are also lifted up to compress the compression spring 91. As the position of the roller portion 94a is lowered due to the shape of the outer surface 62e of the cam portion 62d, the cam follower 94 and the displacement portion 93 are also pushed down according to the expansion of the compression spring 91. The tubular housing portion 95 includes the cam follower arrangement portion 96 at a basal end portion thereof. The roller portion 94a of the cam follower 94 is arranged in the cam follower arrangement portion 96. The roller portion 94a of the cam follower 94 is arranged in the cam follower arrangement portion 96 so as to be displaced (moves up and down) in the shaft direction of the tubular housing portion 95 (the expansion and contraction direction of the compression spring 91).

The rotary plate 62 integrally includes the cam portion 62d that is made of metal material similar to the rotary plate 62. The rotary plate 62 has a substantially disk-like shape as described before and has an arched peripheral edge. The rotary plate 62 includes the outer surface (cam surface) 62e of the cam portion 62d at the arched peripheral edge thereof. As illustrated in FIG. 6, the cam portion 62d has a substantially semicircular shape. A distance from the center O of the waist shaft 61 to the outer surface 62e increases gradually from the front side toward the rear side along the periphery of the cam portion 62d. In this embodiment, as illustrated in FIG. 6, the rotary plate 62 is supported on the waist shaft 61 so that the cam portion 62d is located on the front oblique lower side. For example, as illustrated in FIG. 6, the cam portion 62d has a frontward radius r1 and a rearward radius r2 that is greater than the radius r1. As the radius of the cam portion 62d is greater, the spring compression amount of the compression spring 91 is increased. As a result, a torque generated around the waist shaft 61 is also increased. The cam portion 62d is included in the rotary plate 62 that is rotatably supported on the waist shaft 61 and the rotary plate 62 is fixed on the mount plate 60 as described before. The cam portion 62d is fixed on the mount plate 60 in a predetermined mount position (at a predetermined mount angle).

The mount position of the cam portion 62d is altered by adjusting the mount angle at which the rotary plate 62 is mounted on the mount plate 60. Specifically, one of the pairs of fixing through holes 62c, 62c (five pairs in this embodiment) formed in the rotary plate 62 is selected to be fitted to the respective fixing through holes 60c, 60c of the mount plate 60. The rotary plate 62 is fixed to the mount plate 60 using a predetermined fixing members through the selected fixing through holes 62c, 62c and the fixing through holes 60c of the mount plate 60 so that the mount angle of the cam portion 62d is altered. As the mount angle of the cam portion 62d is altered, the relative positional relationship between the roller portion 94a of the cam follower 94 and the outer surface 62e of the cam portion 62d is altered. The roller portion 94a of the cam follower 94 is configured to move in the front-rear direction along the outer surface 62e of the cam portion 62d according to the movement of the thigh link portion 3 that is rotated (swings) around the waist shaft 61 in the front-rear direction.

As illustrated in FIG. 6, the cam portion 62d has a front end portion 62d1 and a rear end portion 62d2 that are projections. As described before, the distance from the center O of the waist shaft 61 to the outer surface 62e increases gradually from the front side toward the rear side in a range of the outer surface 62e of the cam portion 62d between the front end portion 62d1 and the rear end portion 62d2. The distance from the center O to the front end portion 62d1 and the distance from the center O to the rear end portion 62d2 are greater than the distances at other portions of the outer surface 62e. Accordingly, the roller portion 94a of the cam follower 94 does not climb over the front end portion 62d1 and the rear end portion 62d2.

The torque generated by the torque generator 9 acts on the thigh link portion 3 to move the thigh link portion 3 frontward. The walking assistance device 1 of this embodiment including the torque generator 9 easily and effectively moves the thigh link portion 3 and the lower leg link portion 4 frontward and also the user U easily bends his/her knee joint. As a result, the user U is less likely to stumble during walking.

In the walking assistance device 1 of this embodiment, the upper end portion 3a of the thigh link portion 3 is connected to the waist joint portion 6 having the waist shaft 61, and the lower end portion 3b of the thigh link portion 3 is connected to the knee joint portion 7 having the knee shaft 71. The upper end portion 4a of the lower leg link portion 4 is connected to the knee joint portion 7 having the knee shaft 71. Thus, the walking assistance device 1 of this embodiment is a system having two link portions including the thigh ling portion 3 and the lower leg link portion 4. The walking assistance device 1 is operated based on the passive walking and each of the waist shaft 61 of the waist joint portion 6 and the knee shaft 71 of the knee joint portion 7 is a single axis (a pitch axis).

### (Usage)

A usage of the walking assistance device 1 will be described. First, an example of a method of wearing the walking assistance device 1 will be described. As illustrated in FIG. 3, the user U wears the waist wearing belt 2 of the walking assistance device 1 on his/her waist U3 so that the one pad member 21a is put on the right waist portion U31 and the other pad member 21b is put on the left waist portion U32. The waist wearing belt 2 is put around the waist U3 of the user U. The tightening degree of the waist wearing belt 2 is adjusted so that the pad members 21a, 21b are closely fit on the respective waist side portions U31, U32. The tightening degree of the waist wearing belt 2 is adjusted by altering the lengths of the respective right belt portion 22a and the left belt portion 22b of the adjuster 22. The user U may wear the waist wearing belt 2 with sitting on a chair or standing.

The waist wearing belt 2 is preferably put on slightly above the greater trochanter of the user's pelvis. As described before, the waist wearing belt 2 and the waist joint portion 6 are fixed to each other so as to be detachable from each other with using the hook-and-loop fastener. Therefore, the position of the waist shaft 61 is adjusted to a desired position by adjusting the mount position of the mount plate 60 of the waist joint portion 6 with respect to the waist wearing belt 2 (the receiver portion 23). For example, it may be difficult for a user U who is extremely bent over to previously determine the mount position of the waist joint portion 6 with respect to the waist wearing belt 2. In such a case, in the walking assistance device 1 of this embodiment, the waist joint portion 6 is detachable from waist wearing belt 2. Therefore, the position of the waist shaft 61 is adjusted properly. As described before, the user U wears the walking assistance device 1 so that the waist shaft 61 is slightly above the position of the greater trochanter. The present inventor confirms that, with the above wearing method, the force is likely to be transferred to the right leg U1 and the right leg U1 is moved with more natural walking motion.

Next, the user U bends down slightly and inserts his/her ankle portion into the lower leg wearing portion 5. Then, the user U pushes himself/herself up with his/her lower leg U12 in the lower leg wearing portion 5 and holds himself/herself in a standing position. Then, the lower leg wearing portion 5 is moved upward and the inner surface of the lower leg wearing portion 5 is fit on the front and rear sides of the user's lower leg U12. Accordingly, the lower leg wearing portion 5 is put on the lower leg U12. Thus, the walking assistance device 1 is put on a user. The thigh contact portion 8 is automatically put on a predetermined position of the user's thigh U11 after the wearing of the waist wearing belt 2 and the lower leg wearing portion 5 is completed. Thus, the wearing of the walking assistance device 1 is very easy and may be completed in a few seconds. In one of other wearing methods, the waist wearing belt 2 may be previously separated from other parts of the walking assistance device 1. Thereafter, the separated waist wearing belt 2 and the other parts may be separately put on the user U and they may be fixed to each other with the hook-and-loop fastener.

### (Standing Up)

When the user U wearing the walking assistance device 1 stands up on a flat ground X, the thigh link portion 3 and the lower leg link portion 4 are substantially straight in the vertical direction. The user U wearing the walking assistance device 1 of this embodiment easily and effectively keeps a balanced (in the right-left direction) one-leg standing posture with the affected right leg U1 because the right leg U1 is supported at the three points including the waist wearing belt 2, the lower leg wearing portion 5, and the thigh contact portion 8. Accordingly, the user U stands up in a stable condition. In the walking assistance device 1 of this embodiment, the thigh link portion 3 includes the thigh contact portion 8 that supports the thigh U11 from outside, as described before. The thigh contact portion 8 improves the stability of the right leg U1 and provides the effects of support at the three points. Accordingly, the balanced one-leg standing posture with the right leg U1 wearing the walking assistance device 1 is effectively kept and the user U stands in a stable condition. The present inventor confirms that the user's one-leg standing posture with the right leg U1 wearing the walking assistance device without having the thigh contact portion 8 is unstable. However, in another embodiment, the walking assistance device 1 may be used with the thigh contact portion 8 being detached from the thigh link portion 3, if necessary.

The tubular housing portion 95 of the torque generator 9 is continuous from the housing 63 of the waist joint portion 6 and extends toward the front oblique lower direction. Therefore, when the user U who is in the standing posture sits on a chair, the tubular housing portion 95 is less likely to be in contact with the chair. If the user U swings his/her arms in walking, the arms are less likely to be in contact with the tubular housing portion 95.

### (During Walking)

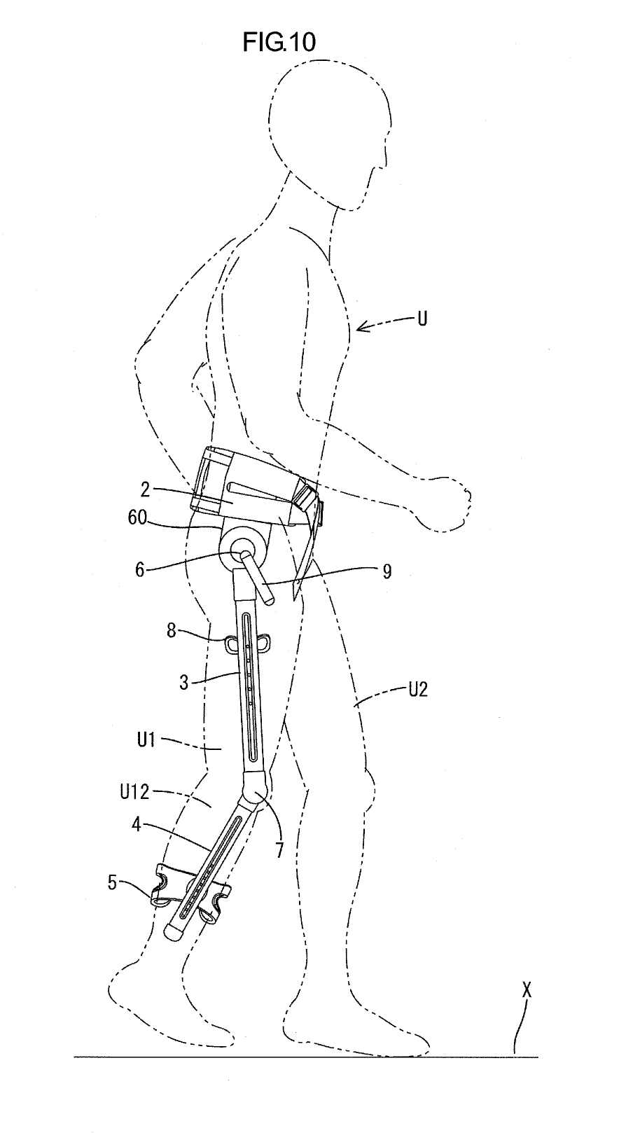

Next, the walking motion of the user U wearing the walking assistance device 1 will be described. In human's walking (of the user U), one of the legs functions as a support leg landing on the ground and the other one of the legs functions as a free leg that is away from the ground. Such a motion is repeated alternately for the right leg U1 and the left leg U2. FIG. 10 is a schematic view illustrating the walking of the user U wearing the walking assistance device 1. In FIG. 10, the left leg (the normal leg) U2 lands on the ground X as the support leg, and the right leg (the affected leg) U1 wearing the walking assistance device 1 is away from the ground X as the free leg. The walking assistance device 1 of this embodiment is operated based on the passive walking and it is considered that the user's left leg U2 is connected to the walking assistance device 1 that is put on the right leg U1 via the waist U3 (pelvis). Namely, the pad member 21a of the waist wearing belt 2 is configured to transfer the motion (the force) of the left leg (the normal leg) U2 to the thigh link portion 3 and the lower leg link portion 4 via the mount plate 60 (the waist joint portion 6) mounted opposite the pad member 21a. As a result, the walking assistance device 1 put on the right leg U1 naturally operates the leg motion to repeat alternately the motion of the free leg and the motion of the support leg according to the motion of the left leg (the normal leg) U2. Namely, the motion of the left leg U2 that is a normal leg is transferred to the walking assistance device 1 put on the right leg U1 so that the leg motion of the right leg U1 during the walking motion is assisted by the walking assistance device 1.

The walking assistance device 1 of this embodiment includes the torque generator 9 using the cam-spring mechanism as described before. Therefore, when the right leg U1 functions as a free leg, the starting of the motion of the right leg U1 is accelerated by the torque generated by the torque generator 9. In this motion, elastic energy accumulated in the compression spring 91 is used. When the right leg U1 functions as the support leg, the elastic energy is accumulated in the compression spring 91 in a last half of the support leg phase. The right leg U1 is less likely to be tilted frontward. As a result, the left leg U2 that functions as the free leg receives less shock in landing on the ground X.

At the initial timing of the starting of the motion of the right leg U1, it is necessary that the knee joint is bent to obviate the contact with the ground X so that the user may not stumble. The lower leg wearing portion 5 is mounted on the lower leg link portion 4 with being tilted rearward with respect to the longitudinal direction of the lower leg link portion 4. Therefore, in walking, the knee joint portion 7 of the walking assistance device 1 is bent prior to the bending of the knee joint of the right leg U1. The present inventor confirms that the walking assistance device 1 assists the leg motion of the right leg U1 and transfers the force (the torque) to the right leg U1 effectively and the knee joint of the right leg U1 is easily and smoothly bent as a result of such a configuration. It is also confirmed that the user U strongly feels that the leg is lifted upward (the knee joint is greatly bent). The lower leg wearing portion 5 may be tilted rearward with respect to the longitudinal direction of the lower leg link portion 4 at an angle ranging from 15° to 30°. The angle is not limited thereto.

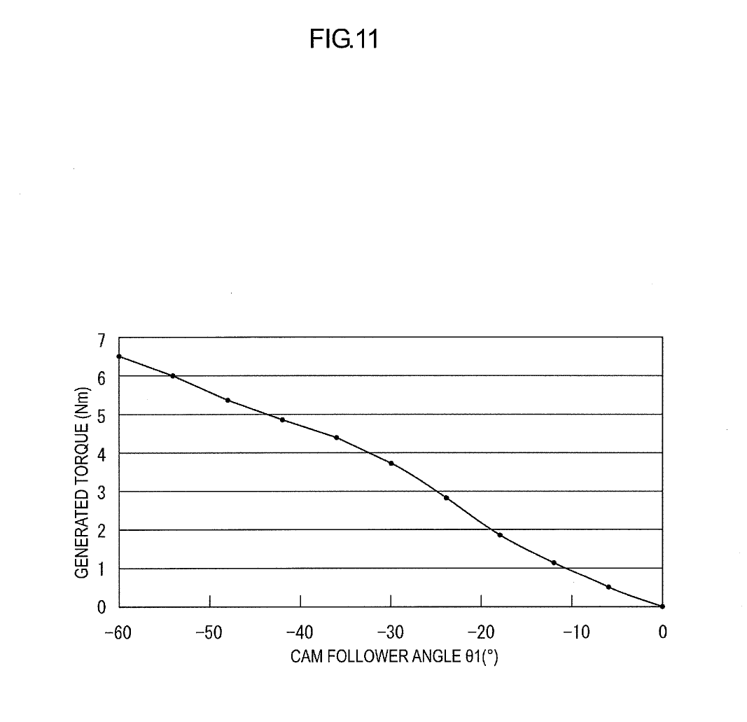

In the walking assistance device 1 of this embodiment, a torque generation range of the torque generated by the torque generator 9 may be altered. FIG. 11 is a graph illustrating torque properties of the torque generated by the torque generator 9. A lateral axis (a cam follower angle θ1) of the graph in FIG. 11 represents an angle θ1 (°) formed between a center line M of the cam portion 62d passing through the center O of the waist shaft 61 and a line C′ passing through the center of the cam follower 94 and the center O of the waist shaft 61 (see FIG. 6). A vertical axis of the graph represents a torque (Nm) generated around the waist shaft 61.

When the upper body (the waist U3) stands upright during walking, the mount plate 60 mounted on the waist wearing belt 2 put on the waist U3 is straight in the substantially vertical direction G. In such a condition, the cam follower 94 is tilted frontward at 20° with respect to the vertical direction G. Further, in this condition, if the cam portion 62 (the rotary plate 62) is arranged so that the cam follower 94 is located at an angle of −20° rearward from the center line M of the cam portion 62d and the thigh link portion 3 is moved in a range from the rearward −20° (absolute angle) to frontward 20° with respect to the vertical direction, the cam follower 94 is moved in a range from −40° to 0°. The torque corresponding to the range of the angle θ1 is generated.

If the cam portion 62 (the rotary plate 62) is arranged so that the cam follower 94 is located at an angle of −35° rearward from the center line M of the cam portion 62d and the thigh link portion 3 is moved in a range from the rearward −20° (absolute angle) to frontward 20° with respect to the vertical direction, the cam follower 94 is moved in a range from −55° to −15°. The torque corresponding to the range of the angle θ1 is generated and the range of the generated torque is higher than the torque range of the above case. The movement range of the cam follower 94 with respect to the outer surface 62e is altered to alter the range of the torque generated by the torque generator 9. Therefore, the user U may alter the movement range of the cam follower 94 according to the environment to adjust the range of the torque generated by the torque generator 9.

In the walking assistance device 1 of this embodiment, the position of the determination portion 92 within the tubular housing portion 95 is altered to alter the spring compression amount of the compression spring 91. Namely, the spring compression amount of the compression spring 91 is easily adjusted by altering the position of the determination portion 92, and eventually the torque generated by the torque generator 9 is adjusted by altering the position of the determination portion 92.

The walking assistance device 1 of this embodiment guides a user U a correct walking motion. The walking assistance device 1 of this embodiment is operated based on the passive walking principle that is closest motion of the humans' walking motion. When the user who has one affected leg (the right leg U1), as is in this embodiment, tries to walk correctly, it has been known that the right leg U1 that is an affected leg moves from the rear side to the front side around himself/herself outwardly in an arc. However, if the user U wears the walking assistance device 1 of this embodiment, the user's affected leg (the right leg U1) is less likely to move around himself/herself outwardly and is guided to move in the front-rear direction.

### Advantageous Effects

In the walking assistance of this embodiment, the thigh link portion 3 is formed of a pair of components (the thigh inner member 31 and the thigh outer member 32) that are made of metal plate members processed into certain shapes. The thigh link portion 3 is constituted by the pair of components that are connected to each other in a tubular shape. Such a thigh link portion 3 is lighter than a thigh link portion made of metal and formed into a bar-like shape. Therefore, the user's load is greatly reduced. In the walking assistance device 1 of this embodiment, the lower leg link portion 4 has a configuration similar to that of the thigh link portion 3. Therefore, the lower leg link portion 4 is lighter than a lower leg link portion made of a metal bar-shaped member and the user's load is greatly reduced. Thus, the thigh link portion 3 and the lower leg link portion 4 are reduced in weight and it is convenient to carry the walking assistance device 1 of this embodiment.

In the walking assistance device 1 of this embodiment, the inner projection portion 31b and the outer projection portion 32b included in the thigh link portion 3 function as a reinforcing member that improves strength of the thigh link portion 3, as described before. Therefore, such a thigh link portion 3 is configured to reduce a thickness thereof and provide sufficient strength to the walking assistance device 1. In the walking assistance device 1 of this embodiment, the lower leg link portion 4 has a configuration similar to that of the thigh link portion 3. Therefore, the lower leg link portion 4 is configured to reduce a thickness thereof and provide sufficient strength to the walking assistance device 1 due to the similar reasons.

The walking assistance device 1 of this embodiment includes the thigh link portion 3 and the lower leg link portion 4 having the above configurations. Therefore, the user U who is wearing the walking assistance device 1 changes his/her posture in the front-rear direction with rotating the waist U3. For example, if the user U who is wearing the walking assistance device 1 rotates (twists) his/her body (waist U3) to move a left shoulder rearward and move a right shoulder frontward (in a counterclockwise direction), a twisting force is applied to the thigh link portion 3 put on the side of the thigh U11 of the right leg U1 and the lower leg link portion 4 put on the side of the lower leg U12 of the right leg U1. The thigh link portion 3 and the lower leg link portion 4 of this embodiment are elastically deformable in a twisting direction to some degree. Therefore, the thigh link portion 3 and the lower leg link portion 4 are less likely to hinder the user's motion of rotating (twisting) his/her body (waist U3). Therefore, the user U can move the right leg U1 wearing the walking assistance device 1 according to the motion of rotating the body (waist U3). The user U who is wearing the walking assistance device 1 can move with rotating or twisting the body in a small space (for example, a kitchen aisle or a restroom stall). The user U1 who is wearing the walking assistance device 1 can rotate his/her body in an opposite direction from the above (namely, in a clockwise direction).

The walking assistance device 1 of this embodiment effectively guides the user U to operate the correct walking motion. The walking assistance device 1 of this embodiment is operated based on the passive walking principle that is closest to the human's walking motion, as described before. Further, the walking assistance device 1 of this embodiment includes the thigh link portion 3 and the lower leg link portion 4 that are elastically deformable in the twisting direction, as described before. Therefore, for example, if the user's affected right leg U1 wearing the walking assistance device 1 would move from the rear side to the front side around himself/herself outwardly in an arc, such a motion is corrected (restricted) to the correct walking motion based on the passive walking due to the elastic force of the thigh link portion 3 and the lower leg link portion 4. Accordingly, the walking assistance device 1 effectively guides the user U to perform the correct walking motion.

In the walking assistance device 1 of this embodiment, the cam portion 62d included in the torque generator 9 is supported on the waist shaft 61 of the waist joint portion 6 so as to rotate (swing) about the waist shaft 61 in the front-rear direction, and the cam portion 62d is included in the rotary plate 62 that is fixed to the mount plate 60. Thus, the cam portion 62d is not provided as a single separate component but formed integrally with a component (the rotary plate 62) that connects the waist joint portion 6 and the mount plate 60 so that the waist joint portion 6 and the mount plate 60 rotate (swing), respectively. The thigh link portion 3 is connected to the waist joint portion 6 and the mount plate 60 is mounted on the waist wearing belt 2. Accordingly, the number of components included in the torque generator 9 is reduced and the torque generator 9 is reduced in size and thickness.

In the walking assistance device 1 of this embodiment, the cam portion 62d included in the torque generator 9 is made of metal and therefore, the roller portion 94a of the cam follower 94 is less likely to be pressed into the cam portion 62d. Therefore, the torque generated by the torque generator 9 is less likely to be reduced due to the cam portion 62d compared to a cam portion made of resin. The cam portion 62d made of metal is less likely to be worn.

In the walking assistance device 1 of this embodiment, the mount angle at which the cam portion 62d included in the torque generator 9 is mounted with respect to the cam follower 94 is adjusted by changing the mount angle at which the rotary plate 62 is mounted on the mount plate 60. As described before, in this embodiment, the rotary plate 62 has five pairs of fixing through holes 62c, 62c and each of the pairs is shifted by 15° in the peripheral direction of the rotary plate 62. Therefore, in this embodiment, the mount angle of the cam portion 62d with respect to the cam follower 94 is adjusted by every 15°.

In the walking assistance device 1 of this embodiment, the lower leg side knee joint portion 72 and the thigh side knee joint portion 73 included in the knee joint portion 7 rotate 360 degrees around the knee shaft 71 when the walking assistance device 1 is not put on a user. Therefore, the lower leg link portion 4 and the thigh link portion 3 can be arranged to overlap each other. Thus, the walking assistance device 1 of this embodiment can be folded into a small size.

In the walking assistance device 1 of this embodiment, the waist wearing belt 2 is put on the user U to be put around the user's waist U3. The pad members 21a, 21b of the waist wearing belt 2 hold the user's waist from the right and left sides. The mount plate 60 included in the waist joint portion 6 is mounted in the receiver portion 23 of the waist wearing belt 2 using the hook-and-loop fastener. In the walking assistance device 1 having such a configuration, the thigh link portion 3 and the lower leg link portion 4 of the walking assistance device 1 is supported only by the waist wearing belt 2. In another embodiment, a shoulder belt may be connected to the waist wearing belt 2 at two ends thereof and the shoulder belt may be put on a user's shoulder to support the waist wearing belt 2.

### (Twisting Properties)

Twisting properties of the thigh link portion 3 and the lower leg link portion 4 included in the walking assistance device 1 of this embodiment will be described. Each of the thigh link portion 3 and the lower leg link portion 4 is formed of two thin elongated processed metal plates. The two thin elongated processed metal plates are connected to each other to have a space therein and form a tubular (columnar)) shape (hereinafter, referred to as a hollow leg member).

When a person (the user U) stands with facing frontward, he/she can twists his/her lower leg in a range of approximately 40° to 50° outwardly and inwardly. A human's lower leg normally generates a twisting torque of approximately 1 Nm. The thigh link portion 3 and the lower leg link portion 4 of the walking assistance device 1 are elastically deformed to be twisted around the shaft (the rotational shaft) along the longitudinal direction thereof in the right and left directions within the twisting range of a human (the user U).

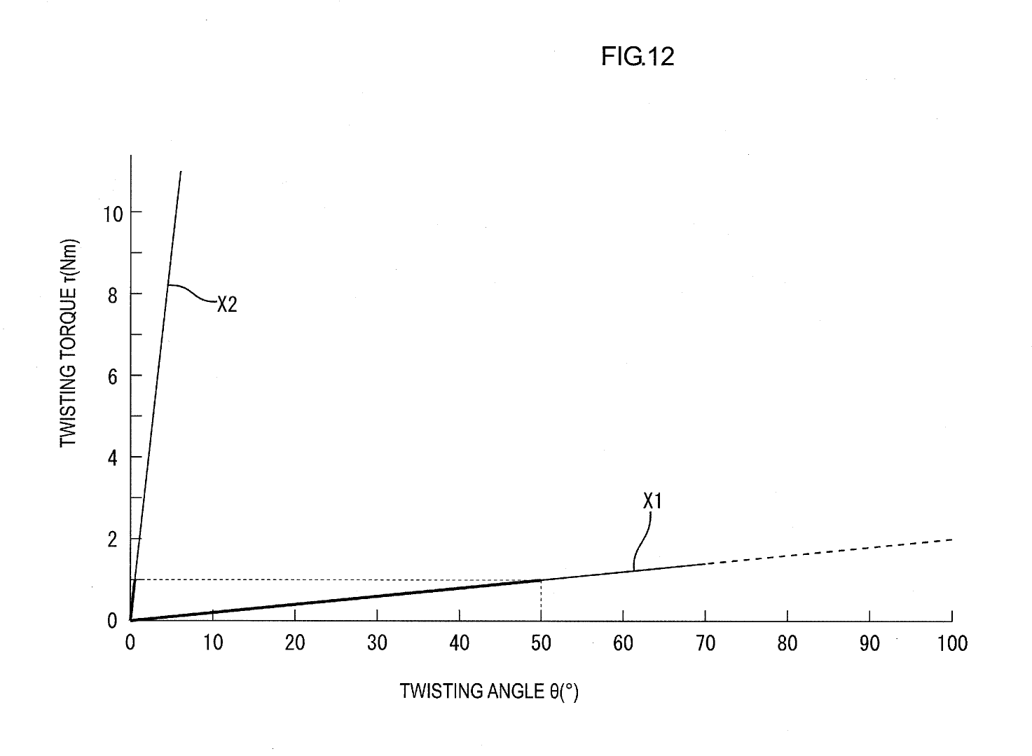

FIG. 12 is a graph illustrating a relationship between a twisting angle θ (°) of the hollow leg member and a generated twisting torque τ (Nm). In FIG. 12, a lateral axis of the graph represents the twisting angle θ (°) and a vertical axis thereof represents the twisting torque τ (Nm). A line X1 illustrated in FIG. 12 represents a relationship between the twisting angle θ (°) of the hollow leg member and the generated twisting torque τ (Nm). A component used for the thigh link portion 3 (40 cm length) is used as the hollow leg member.

The hollow leg member is elastically deformable within the range of the twisting angle θ (°) ranging from 0° to 70° (0≦θ≦70). If the twisting angle exceeds the range, the hollow leg member will be plastically deformed. As illustrated in FIG. 12, the possible twisting angle θ (°) of the hollow leg member is 0≦θ≦50 according to the range of the torque that is normally generated by a human (≦1 Nm). Considering variations, the elastically deformable range, that is, the twisting angle θ (°) at which the hollow leg member can be elastically twisted around the shaft along the longitudinal direction is 0≦θ≦70. Therefore, the hollow leg member can be used with keeping the elastically deformable state within this range.

In FIG. 12, a graph X2 represents relation between a twisting angle θ (°) of a solid leg member formed by machining aluminum material and a generated twisting torque τ (Nm) as a comparative example. As illustrated in FIG. 12, the twisting angle θ (°) at which the solid leg member can be twisted is approximately zero according to the range of the torque that is normally generated by a human (≦1 Nm). The solid leg member having such a range of the twisting angle θ (°) may not provide any advantageous effects caused by the twisting.

The thigh link portion 3 and the lower leg link portion 4 of the walking assistance device 1 are effectively twisted and recovered from the twisted state (have torsion stiffness) while a person (the user U) is walking (including change of direction). Therefore, the walking motion of the user U who wears the walking assistance device 1 is not restricted but may be corrected.

If the thigh link portion and the lower leg link portion have the torsion stiffness that is too high, as is in the comparative example (the solid leg member), the leg (the lower leg) is not effectively twisted with the torque of 1 Nm and the twisting motion is restricted. If the thigh link portion and the lower leg link portion have the torsion stiffness that is too low, the torque sufficient to recover the person's leg (the user's leg) to an original position is not generated and the person's leg is kept with twisted.

Accordingly, it is effective that the thigh link portion 3 and the lower leg link portion 4 are elastically twisted around the shaft along the longitudinal direction thereof within the range of +70° to −70°. “+” represents the outward twisting motion of the leg (the lower leg) and “−” represents the inward twisting motion thereof.

### Second Embodiment

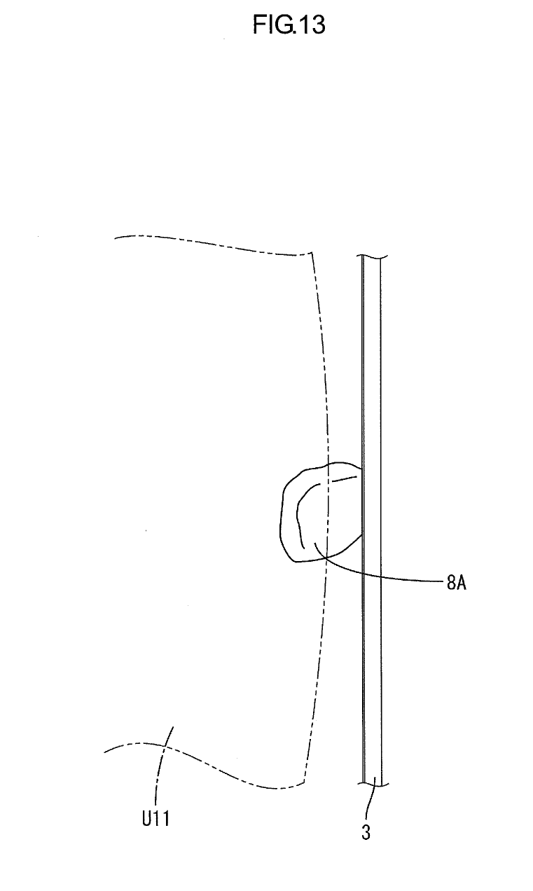

The second embodiment of the present invention will be described with reference to FIG. 13. FIG. 13 is an enlarged rear view of a thigh contact portion 8A included in a walking assistance device of the second embodiment. In the walking assistance device of this embodiment, the thigh contact portion 8A that is contacted with the thigh U11 of the user U is made of elastic material. The thigh contact portion 8A includes the thigh contact portion 8 of the first embodiment and an elastic member that covers a surface of the thigh contact portion 8. The elastic member used for the thigh contact portion 8A is preferably an elastic member made of resin foam having delayed elasticity that easily follows the surface shape of the thigh U11. For example, elastic material used for TEMPUR (registered trademark) may be processed to have a certain shape to be used as the elastic member of this embodiment. With such a thigh contact portion 8A including the elastic member, the force is less likely to be concentrated on the thigh U11 while the user U is wearing the walking assistance device. Therefore, the user U is less likely to feel pain caused by the contact even if the thigh contact portion 8A is in contact with the thigh U11. In another embodiment, a thigh contact portion may be formed to be slightly smaller than the thigh contact portion 8 of the first embodiment and the above elastic member may be attached to a core member to be fixed to the thigh link portion. The walking assistance device of this embodiment has the configuration same as that of the first embodiment other than the thigh contact portion 8A.

### Third Embodiment

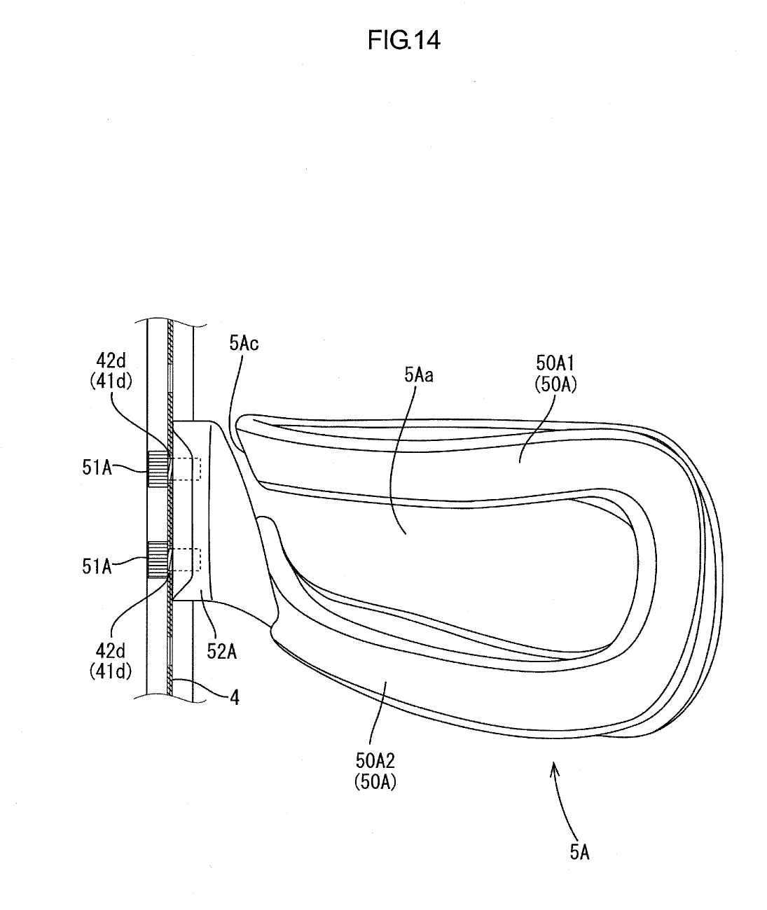

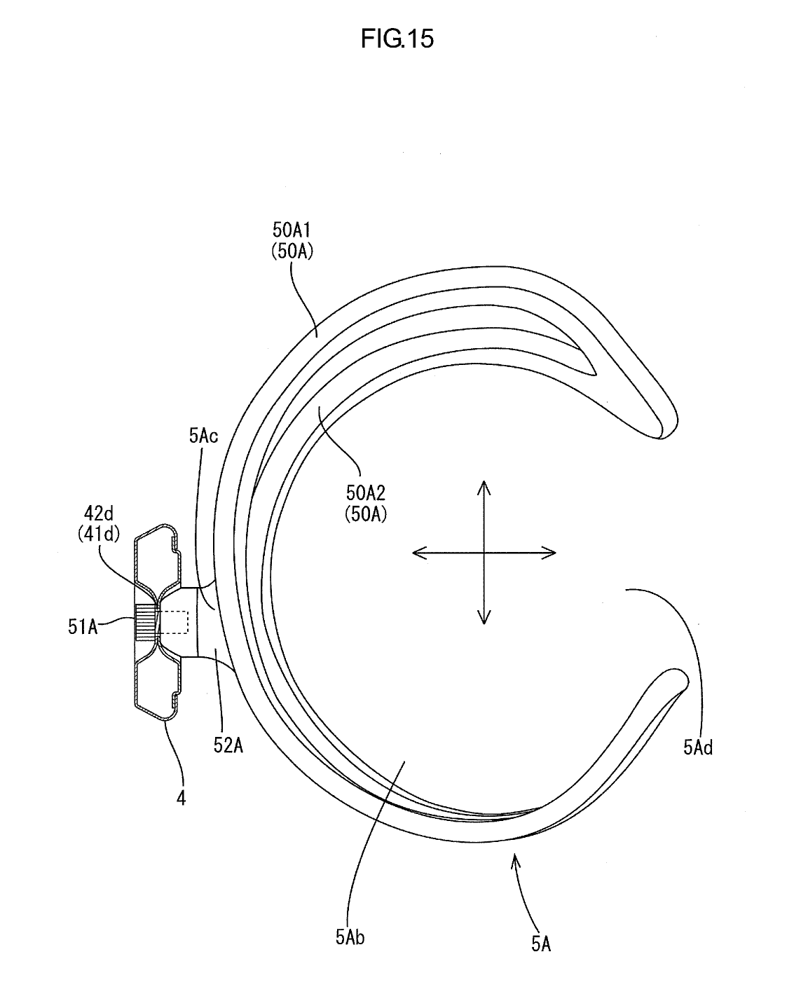

Next, a third embodiment of the present invention will be described with reference to FIGS. 14 and 15. FIG. 14 is a front view of a lower leg wearing portion 5A used in a walking assistance device of the third embodiment. FIG. 15 is a top view of the lower leg wearing portion 5A used in a walking assistance device of the third embodiment. The walking assistance device of this embodiment has the configuration same as that of the first embodiment other than the lower leg wearing portion 5A. The lower leg wearing portion (shin cuff) 5A is put on the lower leg U12 of the user's right leg U1 and has a substantially U shaped tubular shape as a whole so as to hold the lower leg U12 from the front and rear sides. The tubular portion is a main body portion 50A of the lower leg wearing portion 5A. The main body portion 50A is tapered from the upper side to the lower side. With a plan view of the main body portion 50A of the lower leg wearing portion 5A from an outer side (the right side) that is to be fixed to the lower leg link portion 4, the main body portion 50A may include a loop-shaped member that has a hole 5Aa therein and is curved to hold the user's lower leg U12 from the front and rear sides. The main body portion 50A includes an upper portion and a lower portion having the hole 5Aa therebetween. In the loop-shaped main body portion 50A including the upper and lower portions, only the lower portion 50A2 is connected to a base portion 52A that is fixed to the lower leg link portion, and the upper portion 50A1 is away from the base portion 52A. Therefore, a gap 5Ac is formed between the upper portion 50A1 and the base portion 52A.

As illustrated in FIG. 15, the tubular main body portion 50A has a space 5Ab therein and the lower leg U12 is inserted in the space 5Ab. The front end portion of the main body portion 50A is away from the rear end portion thereof and a gap 5Ad is therebetween. The lower leg U12 is inserted in and removed from the main body portion 50A (the space 5Ab) of the lower leg wearing portion 5A through the gap. The lower leg wearing portion 5A of this embodiment is made of synthetic resin that is processed into a predetermined shape and has effective strength and elasticity. Further, in the lower leg wearing portion 5A of this embodiment, the upper portion 50A1 of the main body portion 50A is away from the base portion 52A that is to be fixed to the lower leg link portion 4 and movable in the front-rear direction, the right-left direction and up and down to some extent. Therefore, the main body portion 50A of the lower leg wearing portion 5A is in closely contact with the lower leg U12 with being expanded slightly and effectively and the upper portion 50A1 of the main body portion 50A is movable in the front-rear direction and in the right-left direction according to the motion of the lower leg U12. In the lower leg wearing portion 5A of this embodiment, the lower leg U12 of the user U (especially an upper portion of the lower leg U12) is movable in the front-rear direction and in the right-left direction to some extent with respect to the lower leg link portion 4. Therefore, in the walking assistance device of this embodiment, the lower leg wearing portion 5A is not in contact with the lower leg U12 of the user U (front shin or a rear iliotibial portion) too strongly and the user is less likely to feel pain at the lower leg U12.

The conditions of the lower leg wearing portion 5A such as a size, strength, elasticity are appropriately determined with considering the size, the shape, and the position of the user's lower leg U12. The lower leg wearing portion 5A is detachably fixed to the inner side surface of the lower leg link portion 4 with two screw-shaped fixing members 51A, 51A. The screw-shaped fixing members 51A, 51A are inserted through the through holes 42d, 41d in the lower leg link portion 4 and fixed to the lower leg link portion 4. Distal end portions of the screw-shaped fixing members 51A, 51A are screwed into the base portion 52A of the lower leg wearing portion 5A.

### Fourth Embodiment

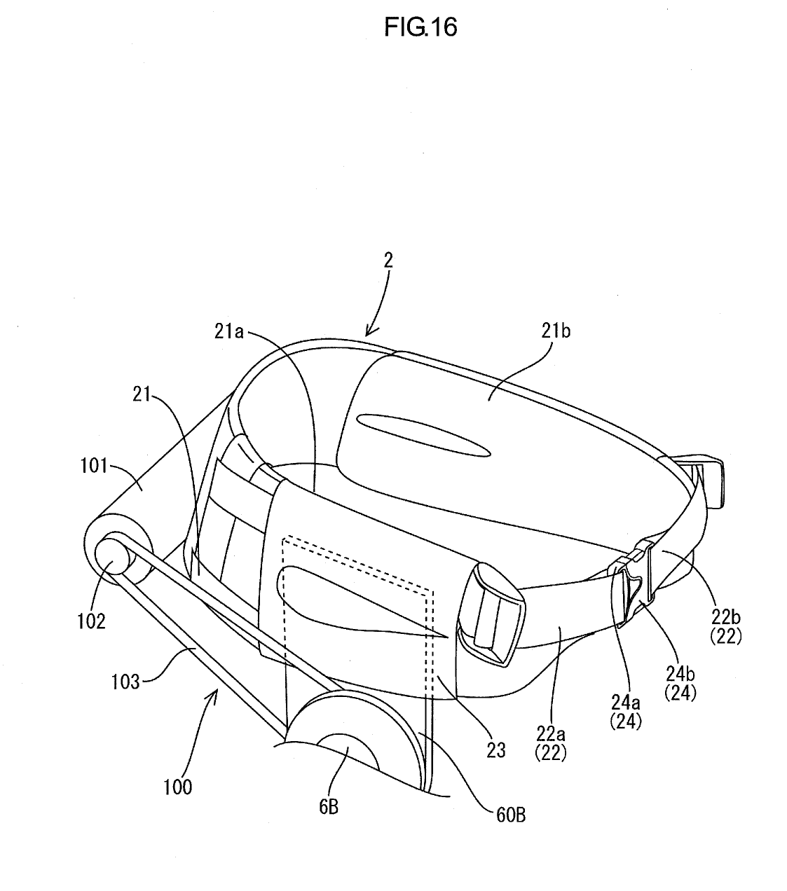

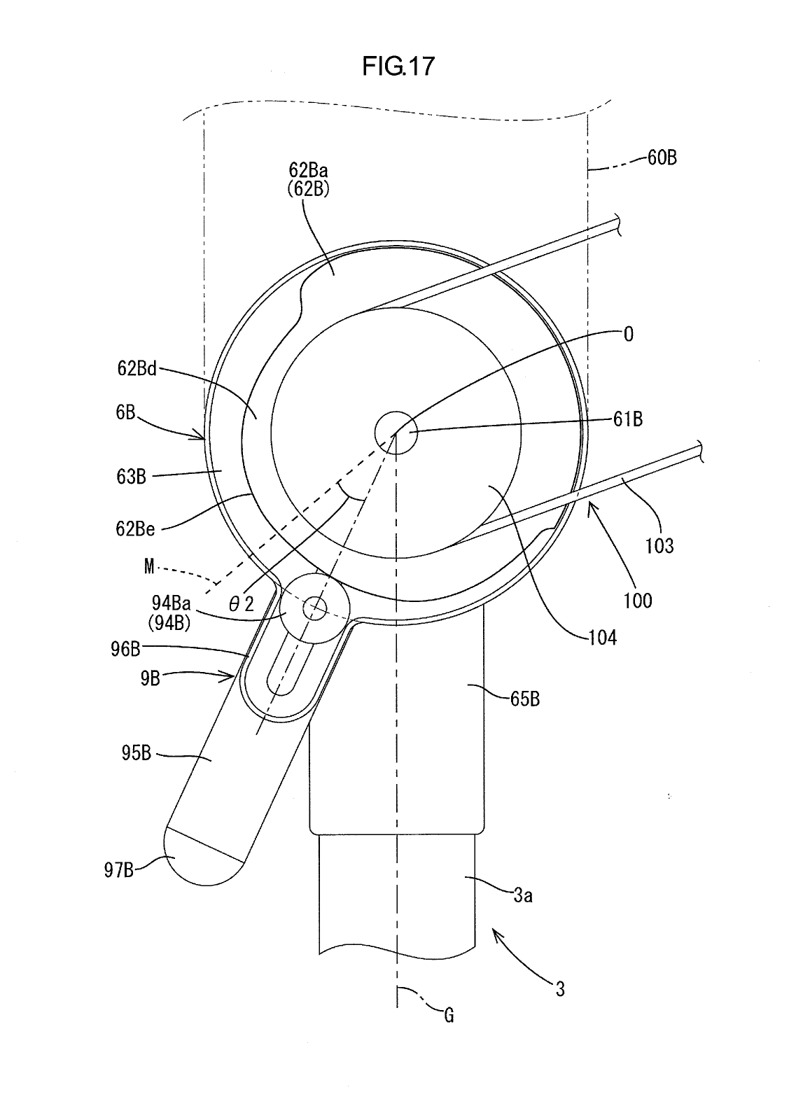

Next, a fourth embodiment of the present invention will be described with reference to FIGS. 16 and 17. FIG. 16 is a perspective view illustrating a cam adjusting device 100 used in a walking assistance device of the fourth embodiment. FIG. 17 is an inner side view of the cam adjusting device 100 used in the walking assistance device of the fourth embodiment. The walking assistance device of this embodiment includes the cam adjusting device 100 that adjust a relative positional relation between a cam portion 62Bb formed on a rotary plate 62B and a roller portion 94Ba of a cam follower 94B. The cam adjusting device 100 mainly includes a servomotor 101, a first pulley 102, a timing belt 103, and a second pulley 104.

In the walking assistance device of this embodiment, one end of a waist shaft 61B of a waist joint portion 6B is fixed to a housing 63B similarly to the first embodiment. In this embodiment, however, another end of the waist shaft 61B is fixed to a mount plate 60B. In this embodiment, an upper end portion of the mount plate 60B is arranged in the receiver portion 23 of the waist wearing belt 2 similarly to the first embodiment. The rotary plate 62B of this embodiment is supported on the waist shaft 61B to rotate (swing) in the front-rear direction similarly to the first embodiment, however, the rotary plate 62B is not fixed to the mount plate 60B. The second pulley (a toothed pulley) 104 is supported on the waist shaft 61B in this embodiment. The second pulley 104 is arranged between the rotary plate 62B and the mount plate 60B. The second pulley 104 is fixed to the rotary plate 62B. Therefore, the rotary plate 62B is rotated according to the rotation of the second pulley 104 around the waist shaft 61B. A main body 62Ba of the rotary plate 62B has an outer appearance shape similar to that of the first embodiment. Namely, the rotary plate 62B of this embodiment includes a cam portion 62Bd and an outer surface (a cam surface) 62Be similar to that of the first embodiment. The timing belt (a toothed belt) 103 is put on the second pulley 104.

As illustrated in FIG. 16, the servomotor 101 is mounted on a rear side of the waist wearing belt 2 (a rear portion of the main body 21). The servomotor 101 rotates a driving shaft (not illustrated) with using electric power supplied from a power supply device. The servomotor 101 controls the rotation of the driving shaft based on commands from a control device, which is not illustrated in the drawings. The driving shaft included in the servomotor 101 has a distal end portion and the first pulley 102 is mounted on the distal end portion. The first pulley 102 has a diameter that is smaller than the diameter of the second pulley 104. The timing belt 103 is also put on the first pulley 102. If the driving shaft of the servomotor 102 is rotated and the first pulley 102 is rotated, the timing belt 103 put on the first pulley 102 is rotated and also the second pulley 104 where the timing belt 103 is put is rotated. The rotary plate 62B that is fixed to the second pulley 104 is rotated according to the rotation of the second pulley 104. Accordingly, the position of the cam portion 62Bd relative to the cam follower 94B (the roller portion 94Ba) is changed.

For example, if a control device (not illustrated) receives a certain signal input by the user U and transmits a driving signal to the servomotor 101, the driving shaft of the servomotor 101 is rotated to rotate the second pulley 104 via the timing belt 103 so that the cam portion 62Bd is shifted by a certain angle with respect to the cam follower 94B (the roller portion 94Ba). Accordingly, in the walking assistance device of this embodiment, the torque range of the torque generated by a torque generator 9B is altered with using the cam adjusting device 100. In this embodiment, the torque range is altered without taking apart the waist joint portion 6B of the walking assistance device.

The torque generator 9B of this embodiment has the torque properties similar to that of the first embodiment illustrated in FIG. 11. The torque properties of the torque generator 9B are represented by the graph in FIG. 11 wherein a lateral axis represents a cam follower angle θ2 instead of the cam follower angle θ1. The cam follower angle θ2 represents an angle θ (°) formed between the center line M of the cam portion 62Bd passing through the center O of the waist shaft 61B and a line passing through the center of the cam follower 94B and the center O of the waist shaft 61B.

In this embodiment, when the upper body (the waist U3) stands upright during walking, the mount plate 60B mounted on the waist wearing belt 2 put on the waist U3 is straight in the substantially vertical direction. In such a condition, the cam follower 94B is tilted frontward at 20° with respect to the vertical direction G. Further, in this condition, if the cam portion 62Bd (the rotary plate 62) is arranged so that the cam follower 94B is located at an angle of −20° rearward from the center line M of the cam portion 62Bd and the thigh link portion 3 is moved in a range from the rearward −20° (absolute angle) to frontward 20° with respect to the vertical direction, the cam follower 94B is moved in a range from −40° to 0° similarly to the first embodiment. The torque corresponding to the range of the angle θ2 is generated.

The servomotor 101 is driven to rotate the second pulley 104 and alter the mount position of the cam portion 62Bd (the mount position of the rotary plate 62B) so that the cam follower 94B is located at an angle of −40° rearward from the center line M of the cam portion 62Bd. Then, if the thigh link portion 3 is moved in a range from the rearward −20° (absolute angle) to frontward 20° with respect to the vertical direction, the cam follower 94B is moved in a range from −20° to −60°. Accordingly, the torque corresponding to the range of the angle θ2 is generated and the torque range of the generated torque is higher than the torque range of the above case. The movement range of the cam follower 94B with respect to the outer surface 62Be is altered with using the cam adjusting device 100 to alter the range of the torque generated by the torque generator 9B. Therefore, the user U may alter the movement range of the cam follower 94B automatically and easily during walking.

### Fifth Embodiment

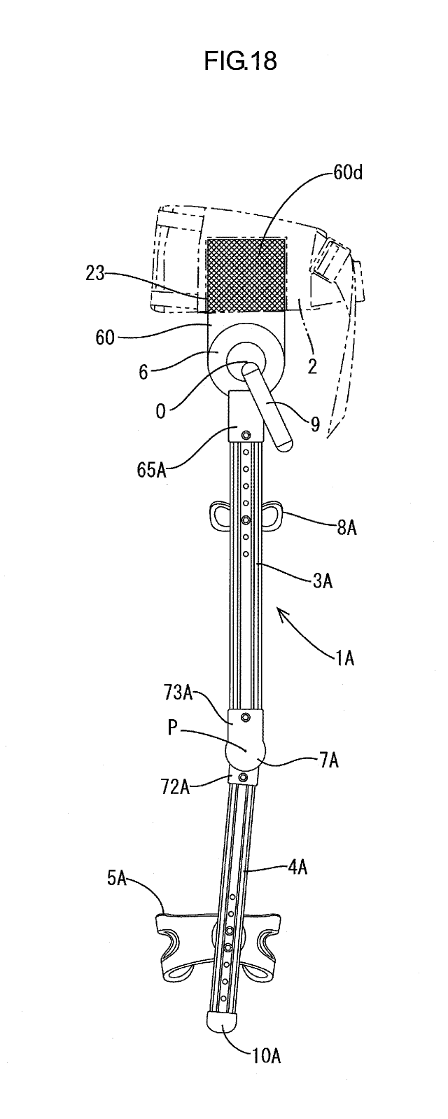

Next, a fifth embodiment of the present invention will be described with reference to FIGS. 18 to 20. FIG. 18 is a side view of a walking assistance device 1A of the fifth embodiment. The walking assistance device 1A of this embodiment mainly includes the waist wearing belt 2, a thigh link portion 3A, a lower leg link portion 4A, a lower leg wearing portion 5A, a waist joint portion 6A, a knee joint portion 7A, the thigh contact portion 8A, and the torque generator 9. The waist wearing belt 2 and the torque generator 9 included in the walking assistance device 1A are same as those of the first embodiment.

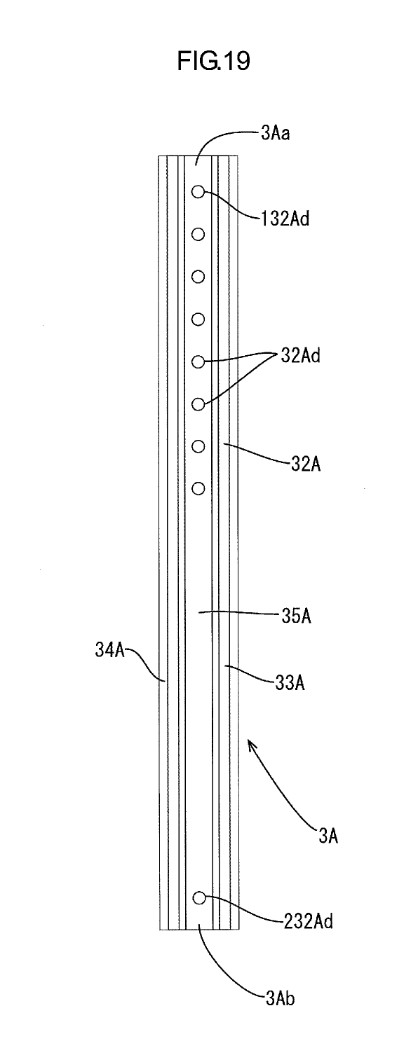

In the walking assistance device 1A of this embodiment, the thigh link portion 3A and the lower leg link portion 4A are detachable from the waist joint portion 6A and the knee joint portion 7A each of which is configured as a module. FIG. 19 is a side view of the thigh link portion 3A of the fifth embodiment. The thigh link portion 3A and the lower leg link portion 4A are formed by processing a metal plate into a predetermined shape, respectively, similarly to the first embodiment. Specifically, the thigh link portion 3A is formed by connecting the thigh inner member 31A and the thigh outer member 32A to be opposed to each other. The thigh link portion 3A includes a pair of tubular portions 33A, 34A and a plate-like connection portion 35A that is located between the tubular portions 33A, 34A and connects them. The lower leg link portion 4A is formed by connecting a lower leg inner member 41A and a lower leg outer member 42A to be opposed to each other. The lower leg link portion 4A includes a pair of tubular portions 43A, 44A and a plate-like connection portion 45A that is located between the tubular portions 43A, 44A and connects them.

An upper end portion 3Aa of the thigh link portion 3A is detachably mounted on a holder 65A of the waist joint portion 6A. A lower end portion 3Ab of the thigh link portion 3A is detachably mounted on a thigh side knee joint portion 73A of the knee joint portion 7A. An upper end portion 4Aa of the lower leg link portion 4A is detachably mounted on a lower leg side knee joint portion 72A of the knee joint portion 7A. The knee shaft 71 and the fixing member 74 included in the knee joint portion 7A have configurations similar to those of the first embodiment.

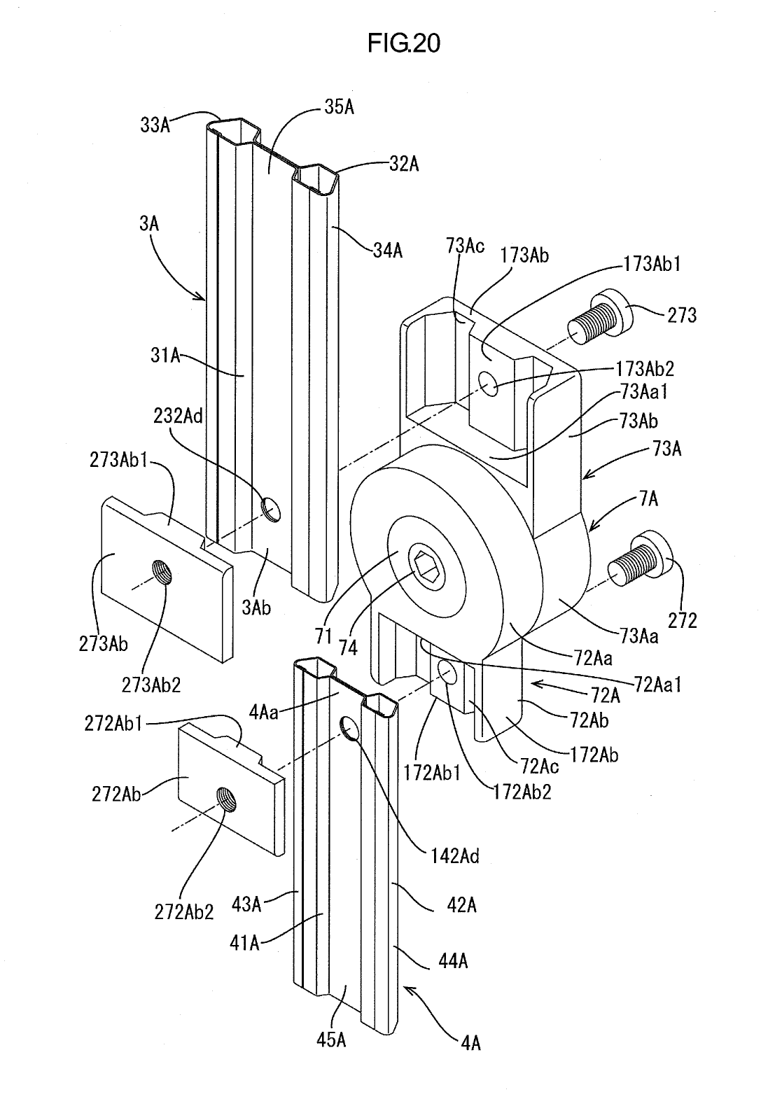

FIG. 20 is an exploded perspective view of a portion of the walking assistance device 1A of the fifth embodiment in the vicinity of the knee joint portion 7A. A mounting structure of the lower end portion 3Ab of the thigh link portion 3A and the thigh side knee joint portion 73A of the knee joint portion 7A will be described with reference to FIG. 20. The thigh side knee joint portion 73A includes a main body 73Aa that mainly overlaps the lower leg side knee joint portion 72A and has a substantially disk-like shape, and a holder 73Ab that is connected to an upper end of the main body 73Aa and holds the lower end portion 3Ab of the thigh link portion 3A.

The holder 73Ab includes a first holder portion 173Ab and a second holder portion 273Ab. The first holder portion 173Ab extends upwardly from the main body 73Aa and the second holder portion 273Ab is a separate component from the first holder portion 173Ab. The holder 73Ab holds the lower end portion 3Ab of the thigh link portion 3A between the first holder portion 173Ab and the second holder portion 273Ab. The lower end portion 3Ab (the lower end surface) of the thigh link portion 3A is held to be in contact with an upper surface 73Aa1 of the main body 73Aa where the first holder portion 173Ab extends upward.

The first holder portion 173Ab and the second holder portion 273Ab have a gap 73Ac therebetween and the lower end portion 3Ab of the thigh link portion 3A is arranged in the gap. The gap 73Ac has a size corresponding to a thickness of the lower end portion 3Ab. The first holder portion 173Ab has a projection portion 173Ab1. The projection portion 173Ab1 is fitted in a recess formed by the tubular portions 33A, 34A of the thigh link portion 3A and the plate-like connection portion 35A. The second holder portion 273Ab has a projection portion 273Ab1. The projection portion 273Ab1 is fitted in a recess formed by the tubular portions 33A, 34A of the thigh link portion 3A and the plate-like connection portion 35A.

The first holder portion 173Ab has a through hole 173ab2 through the projection portion 173Ab1. The second holder portion 273Ab has a screw through hole 273Ab2 through the projection portion 273Ab1. The lower end portion 3Ab of the thigh link portion 3A has a through hole 232Ad through the connection portion 35A. A screw 273 is inserted through the through hole 173Ab2, the through hole 232Ad and the screw through hole 273Ab2 to be tightened. Thus, the lower end portion 3Ab of the thigh link portion 3A is held between the first holder portion 173Ab and the second holder portion 273Ab and held by the holder 73Ab with using the screw 273. If the screw 273 is loosened and removed from the through hole 173Ab2, the through hole 232Ad and the screw through hole 273Ab2, the thigh link portion 3A is easily detached from the holder 73Ab.

Next, a mounting structure of the upper end portion 4Aa of the lower leg link portion 4A and the lower leg side knee joint portion 72A of the knee joint portion 7A will be described with reference to FIG. 20. The lower leg side knee joint portion 72A includes a main body 72Aa that mainly overlaps the thigh side knee joint portion 73A and has a substantially disk-like shape, and a holder 72Ab that is connected to a lower end of the main body 72Aa and holds the upper end portion 4Aa of the lower leg link portion 4A.

A basic configuration of the holder 72Ab of the lower leg side knee joint portion 72A is similar to that of the holder 73Ab of the thigh side knee joint portion 73A. Specifically, the holder 72Ab includes a first holder portion 172Ab and a second holder portion 272Ab. The first holder portion 172Ab is provided at the lower end of the main body 72Aa and the second holder portion 272Ab is a separate component from the first holder portion 172Ab. The holder 72Ab holds the upper end portion 4Aa of the lower leg link portion 4A between the first holder portion 172Ab and the second holder portion 272Ab. The upper end portion 4Ab (the upper end surface) of the lower leg link portion 4A is held to be in contact with a lower surface 72Aa1 of the main body 72Aa where the first holder portion 172Ab extends downward.

The first holder portion 172Ab has a projection portion 172Ab1 and a through hole 172Ab2. The second holder portion 272Ab has a projection portion 272Ab1 and a screw through hole 272Ab2. The first holder portion 172Ab and the second holder portion 272Ab have a gap 72Ac therebetween and the upper end portion 4Aa of the lower leg link portion 4A is arranged in the gap. The gap 72Ac has a size corresponding to a thickness of the upper end portion 4Aa. The upper end portion 4Aa of the lower leg link portion 4A has a through hole 142Ad through the connection portion 45A.

A screw 272 is inserted through the through hole 172Ab2, the through hole 142Ad and the screw through hole 272Ab2 to be tightened. Thus, the upper end portion 4Aa of the lower leg link portion 4A is held between the first holder portion 172Ab and the second holder portion 272Ab and held by the holder 72Ab with using the screw 272. If the screw 272 is loosened and removed from the through hole 172Ab2, the through hole 142Ad and the screw through hole 272Ab2, the lower leg link portion 4A is easily detached from the holder 72Ab.

The holder 65A of the waist joint portion 65A has the configuration similar to that of the holder 72Ab of the lower leg side knee joint portion 72A. The holder 65A detachably holds the upper end portion 3Aa of the thigh link portion 3A. The upper end portion 3Aa of the thigh link portion 3A has a through hole 132Ad that is used when the thigh link portion 3A is mounted on the holder 65A of the waist joint portion 6A.

As illustrated in FIG. 18, the lower end portion 4Ab of the lower leg link portion 4A is covered with a protection cap 10A similar to that of the first embodiment. The protection cap 10A is detachable from the lower end portion 4Ab of the lower leg link portion 4A.

In the walking assistance device 1A of this embodiment, the thigh link portion 3A and the lower leg link portion 4A may be replaced with other components. For example, alternative seven kinds of thigh link portions 3A (an example of a thigh link portion group) are previously prepared. The seven kinds of thigh link portions 3A differ in the longitudinal length thereof by every 20 mm. Specifically, the thigh link portions 3A having entire lengths of 200 mm, 220 mm, 240 mm, 260 mm, 280 mm, 300 mm and 320 mm are previously prepared. Alternative two kinds of lower leg link portions 4A (an example of a lower leg link portion group) are previously prepared. The two kinds of lower leg link portions 4A differ in the longitudinal direction by every 60 mm. Specifically, the lower leg link portions 4A having entire lengths of 200 mm and 260 mm are previously prepared. As described above, the kinds of the thigh link portions 3A and the lower leg link portions 4A that are previously prepared are determined according to the users' builds. They are determined based on Japanese builds and correspond to most of Japanese users. The kinds of the link portions may correspond to people of other nationalities if the maximum value or the minimum value of the entire lengths is changed.

A user or a practitioner such as a doctor or a physical therapist selects one of the various kinds of thigh link portions 3A and the selected thigh link portion 3A is used in the walking assistance device 1A. The user or the practitioner selects one of the various kinds of lower leg link portions 4A and the selected lower leg link portion 4A is used in the walking assistance device 1A.

### (Modularization)

As is in this embodiment, the thigh link portion 3A and the lower leg link portion 4A are configured to be detachably mounted on the waist joint portion 6a and the knee joint portion 7A each of which is modularized. Therefore, the lengths of the thigh link portion and the lower leg link portion are changed according to the user's request (for example, a user's body size) if necessary.

In another embodiment, each of the thigh link portion 3A and the lower leg link portion 4A of the walking assistance device 1A may be replaced with that of the same kind (for example, a new thing link portion 3a or a new lower leg link portion 4A of the same kind or the same size).

One of various kinds of lower leg wearing portions 5A (a lower leg wearing portion group) is selected according to a size and a shape of the user's lower leg (including a lower limb orthosis).

### Sixth Embodiment

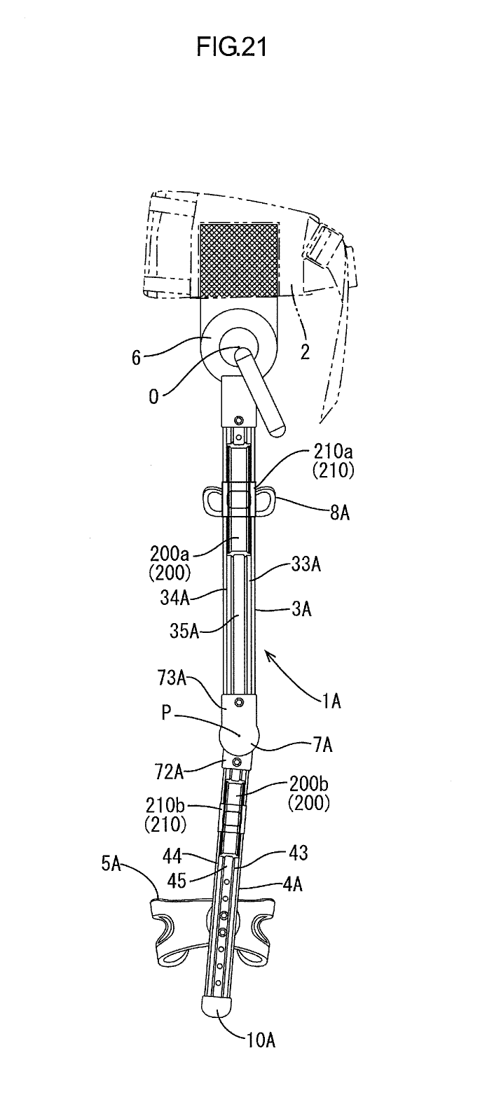

Next, a sixth embodiment of the present invention will be described with reference to FIGS. 21 to 27. In this embodiment, a walking assistance device including a weight will be described. FIG. 21 is a side view of a walking assistance device 1A where a weight 200 is attached. In FIG. 21, the weight 200 is attached to the walking assistance device 1A of the fifth embodiment.

The weight 200 is attached to the thigh link portion 3A and the lower leg link portion 4A of the walking assistance device 1A. A weight 200a is attached to the thigh link portion 3A and a weight 200b is attached to the lower leg link portion 4A.

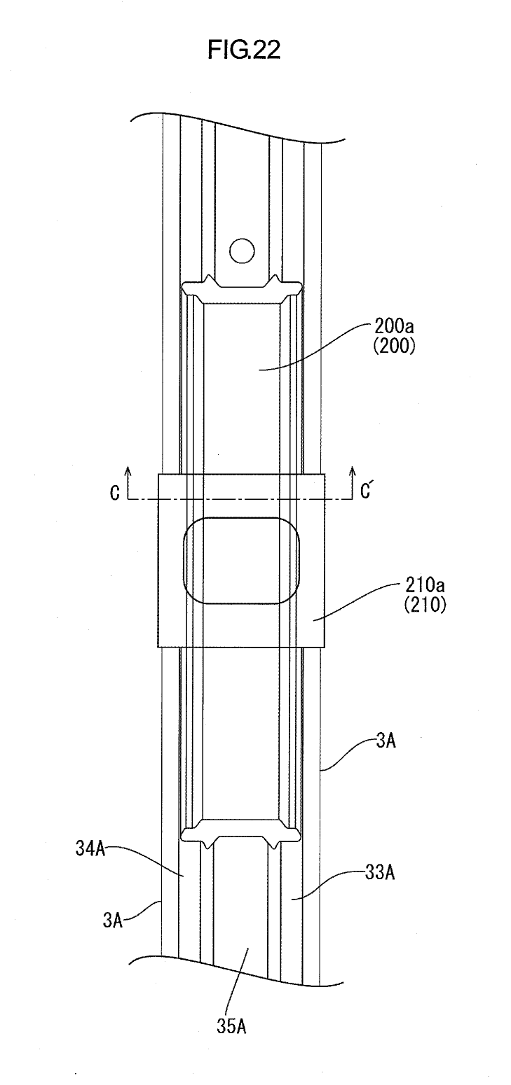

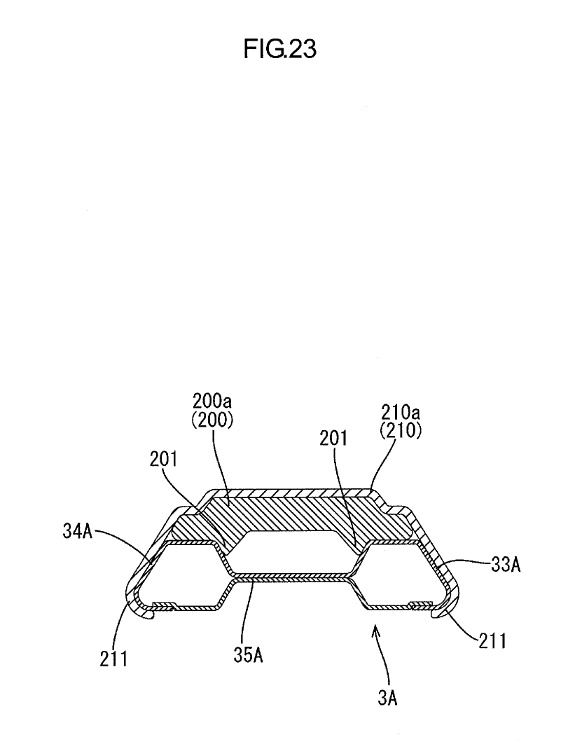

FIG. 22 is an enlarged view of the weight 200a attached to the thigh link portion 3A, and FIG. 23 is a cross sectional view taken along line C-C′ in FIG. 22. The weight 200a has an elongated bar-like shape as a whole and is fit in the recess portion formed by the tubular portions 33A, 34A and the connection portion 35A of the thigh link portion 3A. The weight 200a includes projections 201 that are fit in the recess portion of the thigh link portion 3A.

The weight 200a is mainly made of metal material such as brass. In this embodiment, the weight 200a has a magnet (not illustrated) built-in and is adhered to the metal thigh link portion 3A with a magnetic force. The weight 200a is fixed to the thigh link portion 3A with using a fixing member 210a (210) having a substantially arched shape. The fixing member 210a (210) is made of plastic material or metal material. As illustrated in FIG. 23, two end portions 211, 211 of the fixing member 210a (210) are curved like a hook to face each other. The two end portions 211, 211 are elastically deformed to be fit to end portions of the thigh link portion 3A, respectively, so that the fixing member 210a (210) is fixed to the thigh link portion 3A. The weight 200a is held between the fixing member 210a (210) and the thigh link portion 3A. If the fixing member 210a (210) is pulled away from the thigh link portion 3A, the end portions 211 are elastically deformed outwardly and the fixing member 210a (210) is easily detached from the thigh link portion 3A. Thus, the weight 200a is detachably mounted on the thigh link portion 3A.

The weight 200b that is attached to the lower leg link portion 4A has a basic configuration same as that of the weight 200a for the thigh link portion 3A. The weight 200b is attached to the lower leg link portion 4A with using a fixing member 210b (210).

In another embodiment, the weight 200 may not include the magnet and may be attached to a predetermined position of the thigh link portion 3A or the lower leg link portion 4A only with the fixing member 210.

In this embodiment, the weight 200a attached to the thigh link portion 3A weighs 130 g and the weight 200b attached to the lower leg link portion 4A weighs 60 g. Weights of the weight 200a attached to the thigh link portion 3A and the weight 200b attached to the lower leg link portion 4A may be changed according to the user's request. A user or a practitioner such as a doctor or a physical therapist selects one of various kinds of weights (a weight group) having different weights according to the condition of the user's affected leg that the walking assistance device is to be put on, the user's symptom and a walking condition. The weight 200 may be attached to both of the thigh link portion 3A and the lower leg link portion 4A, or may be attached to only one of the thigh link portion 3A and the lower leg link portion 4A.

The weight 200a may be attached to a portion of the thigh link portion 3A on the upper end portion 3Aa side or on the lower end portion 3Ab side. The weight 200a may be attached to a middle portion of the thigh link portion 3A. Namely, the attachment position of the weight 200a is not limited but may be determined according to the user's symptom and walking condition by the user or the practitioner such as a doctor and a physical therapist.

(Simulation of Motion of Walking Assistance Device with Weight)

Motions of the thigh link portion and the lower leg link portion of the walking assistance device with the weight are simulated with using a computer. Conditions for the simulation are as follows.

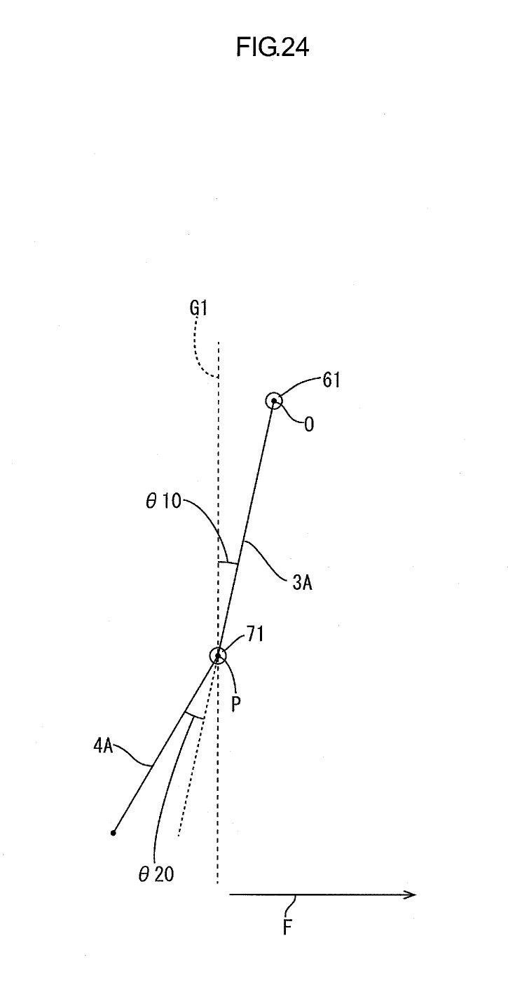

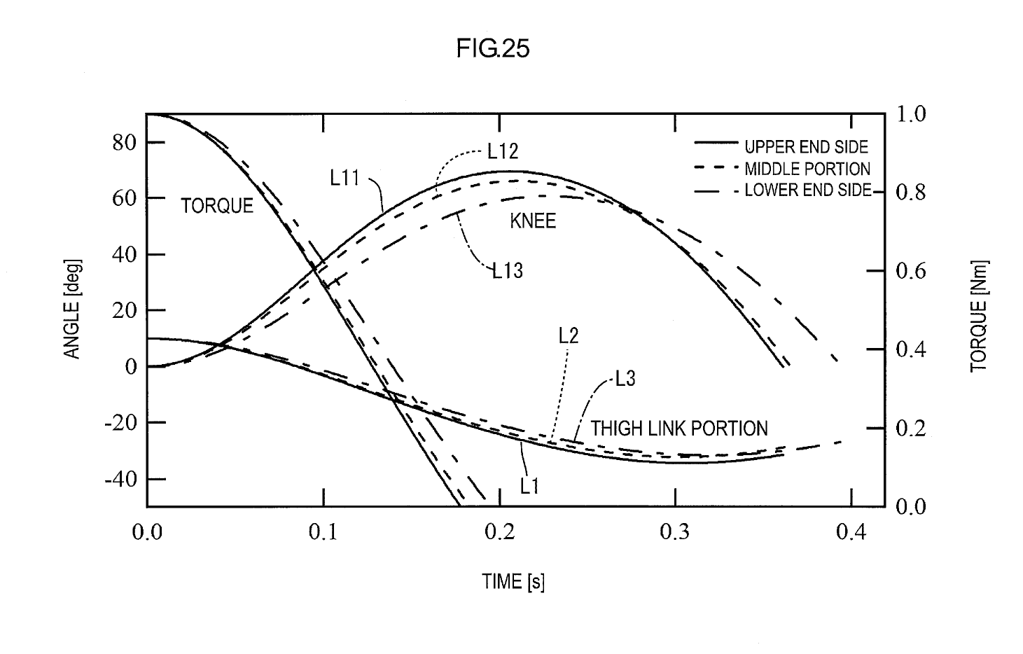

Simulated motions of a walking assistance device having a mechanism using double link portions are illustrated in FIG. 24. An angle (absolute angle) θ10 and an angle (relative angle) θ20 are illustrated in FIG. 24. The angle (absolute angle) θ10 is formed between the thigh link portion 3A that swings about the center of the waist axis 61 and a vertical line G1 passing through a center P of the knee shaft 71, and the angle (relative angle) θ20 is formed between the thigh link portion 3A and the lower leg link portion 4A that swing about the center P of the knee shaft 71. An arrow F in FIG. 24 represents a frontward direction of the walking assistance device. As illustrated in FIG. 24, the motion of the walking assistance device 1A of a double link portions model (double pendulum model) including the thigh link portion 3A and the lower leg link portion 4A is simulated. The walking assistance device of the double link portions model includes the thigh link portion 3A having a length of 320 mm and the lower leg link portion 4A having a length of 260 mm. The weights of the thigh link portion 3A and the lower leg link portion 4A are 100 g and 70 g, respectively. The weight attached to the thigh link portion 3A weights 130 g and the weight attached to the lower leg link portion 4A weighs 60 g. In an initial condition, the thigh link portion 3A and the lower leg link portion 4A that are straight are tilted rearward by 10° from a straight posture. In the simulation, a torque is applied to the thigh link portion 3A and the lower leg link portion 4A that are in the initial condition around the center O of the waist shaft 61 to perform the double pendulum movement. The torque is reduced to a range from 1 Nm to 0 Nm while the thigh link portion 3A swings (see FIG. 25). The simulation is performed three times with changing the position of the weights. Namely, one of the simulations is performed with the weights on the upper end portions of the thigh link portion 3A and the lower leg link portion 4A, another one is performed with the weights on the middle portions thereof, and the other one is performed with the weights on the lower end portions thereof.

FIG. 25 illustrates graphs one of which represents time-dependent change of the angles (absolute angle) θ10 and another one of which represents time-dependent change of the angles (relative angle) θ20. The angle (absolute angle) θ10 is formed between the thigh link portion 3A that swings about the center O of the waist axis 61 and the vertical line G1 passing through the center P of the knee shaft 71, and the angle (relative angle) θ20 is formed between the thigh link portion 3A and the lower leg link portion 4A that swing about the center P of the knee shaft. The angle (absolute angle) θ10 formed between the thigh link portion 3A that swings about the center O of the waist axis 61 and the vertical line G1 passing through the center P of the knee shaft 71 is represented with plus (+) when the thigh link portion 3A is located frontward with respect to the vertical line G1 and the angle θ10 is represented with minus (−) when the thigh link portion 3A is located rearward with respect to the vertical line G1 (see FIG. 24). Further, the graph L1 represents time-dependent change with the weights on the upper end portions of the thigh link portion 3A and the lower leg link portion 4A. The graph L2 represents time-dependent change with the weights on the middle portions of the thigh link portion 3A and the lower leg link portion 4A. The graph L3 represents time-dependent change with the weights on the lower end portions of the thigh link portion 3A and the lower leg link portion 4A.

The angle (relative angle) θ20 that is formed between the thigh link portion 3A and the lower leg link portion 4A that swing about the center P of the knee shaft is 0° when the thigh link portion 3A and the lower leg link portion 4A are on a line. The angle θ20 is greater than 0° when the thigh link portion 3A and the lower leg link portion 4A approach each other. In FIG. 25, the graph L11 represents time-dependent change with the weights on the upper end portions of the thigh link portion 3A and the lower leg link portion 4A. The graph L12 represents time-dependent change with the weights on the middle portions of the thigh link portion 3A and the lower leg link portion 4A. The graph L13 represents time-dependent change with the weights on the lower end portions of the thigh link portion 3A and the lower leg link portion 4A.

As illustrated in FIG. 25, if the weights are attached to the upper end portions or the middle portions, the time-dependent change (inclination of the graph) of the swing angles θ10 of the thigh link portion 3A becomes greater and the maximum value of the knee angle θ20 becomes greater, and a walking pitch (time) is decreased. If the weights are attached to the lower end portions, the maximum value of the knee angle θ20 becomes smaller and the walking pitch (time) is increased. The walking assistance device itself having no power can change a swing pattern by changing the attachment positions of the weights. Therefore, the balanced weight (weights of the weights and balanced attachment positions of the weights) is kept in the walking assistance device according to the user's symptom and walking condition to improve walking.

(Actual Measurement of Motion of Walking Assistance Device with Weight)

Next, when a user wearing the walking assistance device with the weights walks, the motions of the thigh link portion and the lower leg link portion of the walking assistance device during the walking are analyzed in the following steps.

In the walking assistance device 1A with the weights illustrated in FIG. 21, a marker is provided on each of the waist joint portion (the waist shaft), the knee joint portion (the knee shaft), and the lower end portion (the protection cap 10A) of the lower leg link portion 4A. A user (a person being tested) who wears the walking assistance device 1A with the markers on his/her right leg walks. The length of the thigh link portion 3A of the walking assistance device 1A is 320 mm and the weight of 190 g is attached to the upper end portion of the thigh link portion 3A. The length of the lower leg link portion 4A is 260 mm and the weight of 190 g is attached to the upper end portion of the lower leg link portion 4A.

Next, images of the user who is wearing the walking assistance device 1A and walks are taken with a highly sensitive camera to obtain videos of the motions of the walking assistance device 1A. Tracing data of each marker is extracted from the obtained videos (image data). Time-dependent change data of the angles (absolute angle) θ10 and time-dependent change data of the angles (relative angle) θ20 are obtained from the extracted data. The angle (absolute angle) θ10 is formed between the thigh link portion 3A that swings about the center O of the waist axis 61 and the vertical line G1 passing through the center P of the knee shaft 71 and the angle (relative angle) θ20 is formed between the thigh link portion 3A and the lower leg link portion 4A that swing about the center P of the knee shaft. The measurement method of the angles θ10 and the angles θ20 is same as that in the above simulations (see FIG. 24).

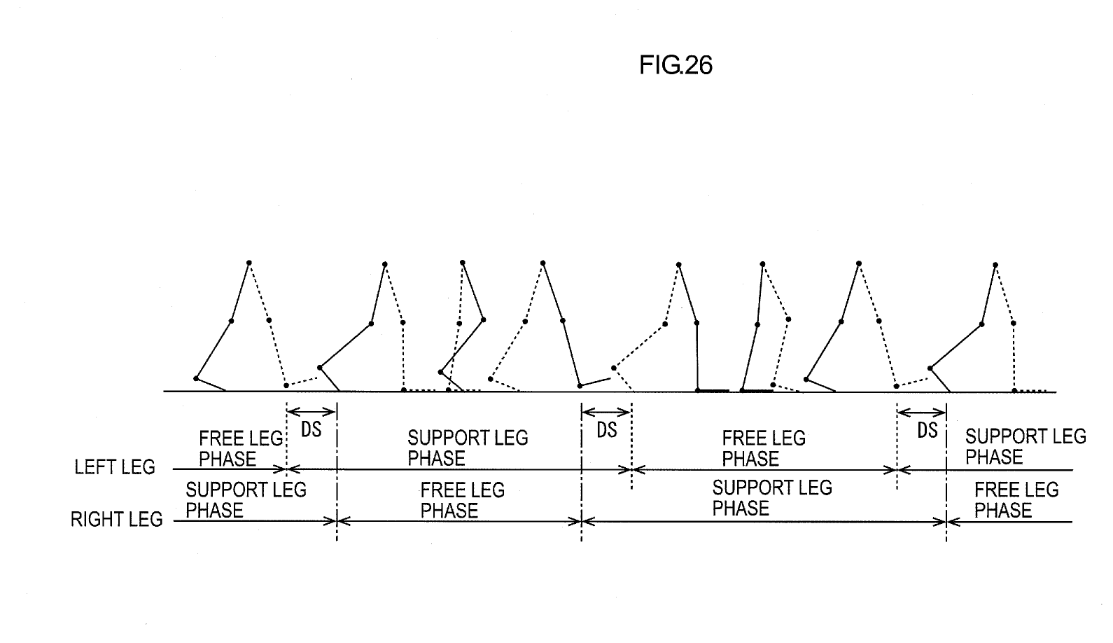

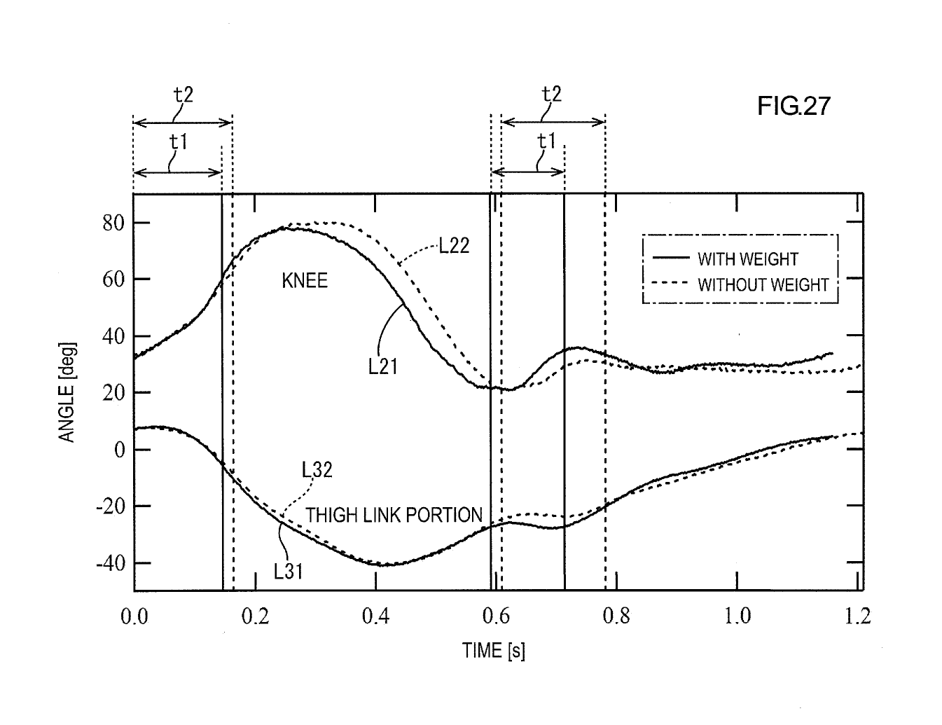

Data of the angles θ10 and data of the angles θ20 for one cycle of the walking motion are obtained. In this embodiment, a walking cycle starts at a double support phase when the right leg wearing the walking assistance device 1A is located on a rear floor surface and the left leg is located on a front floor surface. The walking cycle is illustrated in FIG. 26. The obtained data of the angles θ10 and the angles θ20 is represented as graphs in FIG. 27. Data of the angles θ10 and the angles θ20 obtained with the walking assistance device 1A without the weights are obtained as a comparative example. The data of the comparative example is represented as graphs in FIG. 27.

In FIG. 27, a solid line L21 represents data (a graph) of the angles θ20 (the knee angle) with the walking assistance device 1A including the weights, and a dotted line L22 represents data (a graph) of the angles θ20 (the knee angle) with the walking assistance device 1A without the weights.

In FIG. 27, a solid line L31 represents data (a graph) of the angles θ10 (the swing angle of the thigh link portion) with the walking assistance device 1A with the weights, and a dotted line L32 represents data (a graph) of the angles θ10 (the swing angle of the thigh link portion) with the walking assistance device 1A without the weights. A period t1 in FIG. 27 represents the double support phase with the weights and a period t2 represents the double support phase without the weights.

As illustrated in FIG. 27, when the leg wearing the walking assistance device 1A is at a free leg phase, the maximum value of the angle θ20 (the knee angle) is slightly smaller in the walking assistance device 1A with the weights than that without the weights (in a range from 0.2 to 0.4 seconds in FIG. 27) and the time-dependent change of the angles θ10 (the swing angle of the thigh link portion) is slightly greater in the walking assistance device 1A with the weights than that without the weights (in the vicinity of 0.2 seconds in FIG. 27). The user wearing the walking assistance device 1A with the weights feels like his/her leg being moved forward rather than being lifted up and feels like increasing the length of stride. The movement distance of the leg is 123 cm without the weights and 134 cm with the weights. The walking pitch (time) is smaller in the device with the weights than the device without the weights. The user wearing the walking assistance device 1A increases the length of stride and walks smoothly. Accordingly, the walking is effectively improved.

### Other Embodiments

The present invention is not limited to the embodiments described above with reference to the drawings and following embodiments are included in the technologies of the present invention.

(1) In the above embodiments, the walking assistance device is put on the right leg. However, the walking assistance device may be put on the left leg in another embodiment.

(2) In the above embodiments, the walking assistance device is put on only one leg (the right leg). However, a walking assistance device may be mounted on right and left portions of the waist wearing belt in another embodiment.

(3) In the above embodiments, the thigh link portion and the lower leg link portion are connected to each other via the knee joint portion. However, in another embodiment, the walking assistance device of the first embodiment may not include the knee joint portion, the lower leg link portion, and the lower leg wearing portion. Such a walking assistance device assists the motion of the user's leg (the right leg, for example) wearing the walking assistance device during the walking. In such a configuration, it is preferable to hook a belt on the thigh contact portion 8 and provide it around the thigh U11.

(4) In the above embodiments, the thigh link portion includes the thigh contact portion. However, the thigh link portion may not include the thigh contact portion in another embodiment.

(5) In the above embodiments, the mount plate is mounted on the waist wearing belt with the hook-and-loop fastener. However, the mount plate may be mounted on the waist wearing belt with other known mounting means in another embodiment. It is preferable that the mount plate is detachably mounted on the waist wearing belt as is in the above embodiments.

(6) According to the third embodiment, the lower leg wearing portion 5A has the gap 5Ac between the upper portion 50A1 of the main body portion 50A and the base portion 52A that fixes the lower wearing portion 5A to the lower leg link portion 4. However, a hinge portion may be provided to connect the base portion 52A and the upper portion 50A1 in another embodiment. With such a hinge portion, the upper portion 50A1 of the main body portion 50A included in the lower leg wearing portion 5A is allowed to move in the front-rear direction and is less likely to move in the up-down direction. Namely, with the hinge portion, the lower leg wearing portion is less likely to move in the up-down direction so that the motion of the lower leg link portion is likely to be transferred to the user's lower leg.

(7) In the above embodiments, each of the components constituting each of the thigh link portion and the lower leg link portion is made of metal plate. However, each of the components constituting each of the thigh link portion and the lower leg link portion may be a resin member (a resin molded item, for example).

(8) In the above embodiments, the torque generator is configured to generate a torque to move the thigh link portion frontward of the user. However, the toque pattern generated by the torque generator may be changed in another embodiment. For example, the torque generator may be configured to generate a toque to move the thigh link portion toward the user that is in an opposite direction from that in the first embodiment.

(9) In the first embodiment, the mount plate 60 has a pair of fixing through holes 60c, 60c. However, the mount plate 60 may have two pairs of fixing through holes 60c, 60c or more. The adjacent pairs of the fixing through holes 60c, 60c are away from each other by 10° (namely, the fixing through holes 60c are formed around the waist shaft 61 at every 10°). Accordingly, the mounting position of the cam portion 62d (the outer surface 62e) of the rotary plate 62 (the position of the cam portion 62d with respect to the cam follower 94 (the roller portion 94a)) is changed by every 5° according to combinations of the fixing through holes 60c and the fixing through holes 62c, 62c that are formed in the rotary plate 62 (at every 15°). Thus, the mounting position (the angle) of the cam portion 62d may be adjusted with using the fixing through holes 62c, 62c of the rotary plate 62 and also the fixing through holes 60c, 60c formed in the mount plate 60.

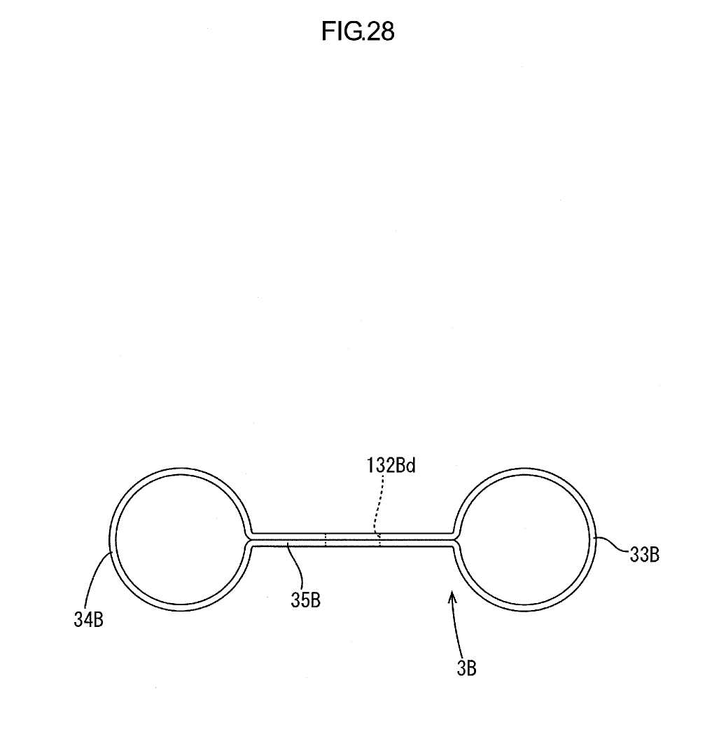

(10) FIG. 28 is a cross-sectional view of a thigh link portion 3B according to a modification. The thigh link portion 3B is formed by pressing a tubular metal member (having a pipe shape) to form a connection portion 35B and elongated tubular portions 33B, 34B that sandwich the connection portion 35B therebetween. The thigh link portion 3B includes a through hole 132Bd in an upper end portion thereof as is in FIG. 28. Thus, the thigh link portion 3B is produced by processing one tubular member. The lower leg link portion may have the configuration same as that of the thigh link portion 3B. The tubular portions 33B, 34B of the thigh link portion 3B does not necessarily have circular cross sectional shape but may have an ellipsoidal cross sectional shape or a polygonal cross sectional shape (such as a square).

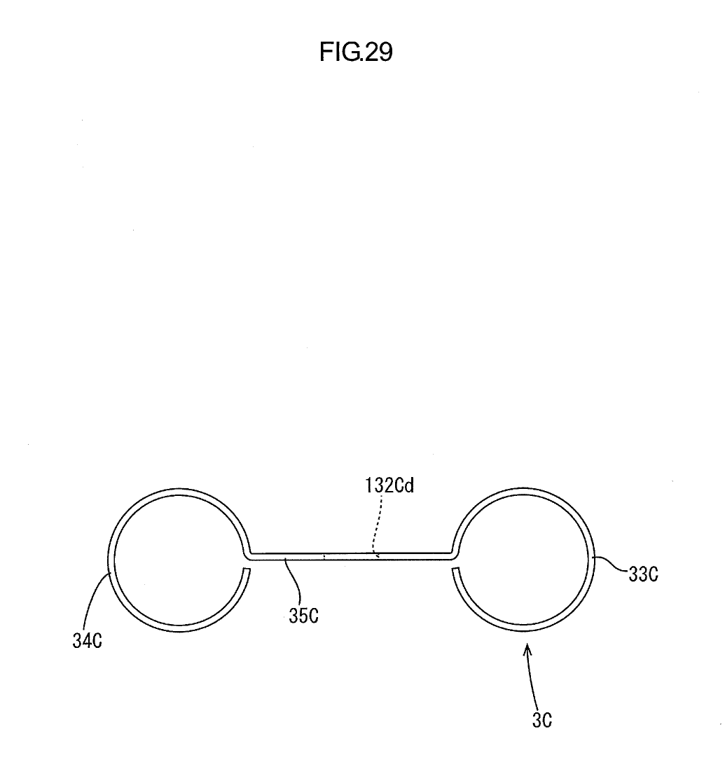

(11) FIG. 29 is a cross-sectional view of a thigh link portion 3C according to another modification. The thigh link portion 3C is formed by processing a metal plate to have tubular shapes at two side portions. The thigh link portion 3C includes a plate-like connection portion 35C at a middle portion thereof and a pair of tubular portions 33C, 34C that sandwich the connection portion 35C therebetween. A thickness of the connection portion 35C is effectively determined according to the strength required for the thigh link portion 3C. Portions of the metal plate corresponding to the tubular portions 33C, 34C may be subjected to connection processing such as welding. The thigh link portion 3C includes through hole 132Cd in an upper end portion thereof as illustrated in FIG. 29. Thus, the thigh link portion 3C may be produced by processing a metal plate member. The lower leg link portion may have the configuration same as that of the thigh link portion 3C.

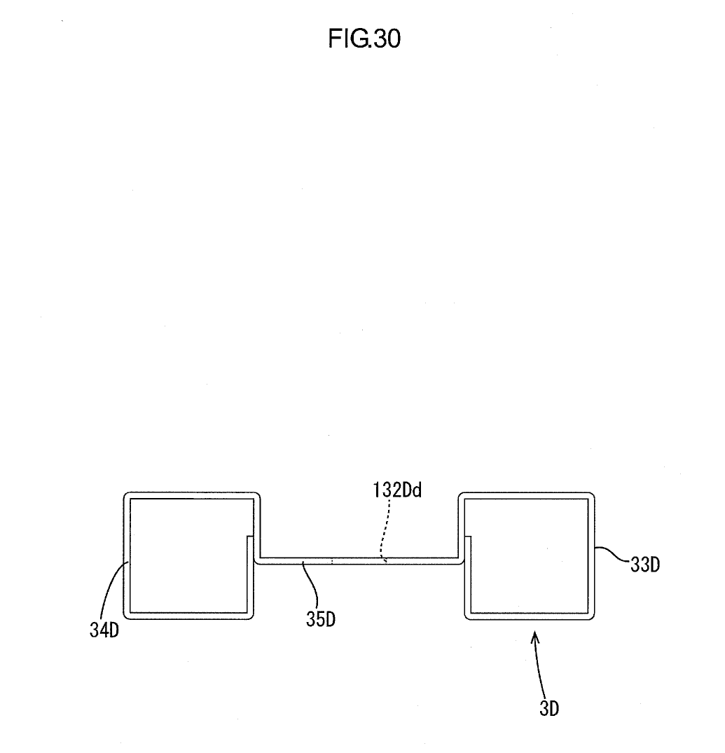

(12) FIG. 30 is a cross-sectional view of a thigh link portion 3D according to another different modification. The thigh link portion 3D is formed by processing a metal plate to have square tubular shapes at two side portions. The thigh link portion 3D includes a plate-like connection portion 35D at a middle portion thereof and a pair of tubular portions 33D, 34D that sandwich the connection portion 35D therebetween. A thickness of the connection portion 35D is effectively determined according to the strength required for the thigh link portion 3D. Portions of the metal plate corresponding to the tubular portions 33D, 34D may be subjected to connection processing such as welding. The thigh link portion 3D includes through hole 132Dd in an upper end portion thereof as illustrated in FIG. 30. Thus, the thigh link portion 3D may be produced by processing a metal plate member. The lower leg link portion may have the configuration same as that of the thigh link portion 3D.

(13) Other than SECC, known metal members such as cold rolled carbon steel sheets and strip (SPCC) or hot rolled mil steel plates, sheets and strip (SPHC) may be used for the thigh link portion. The metal members may be subjected to surface treatment such as galvanizing and coating.

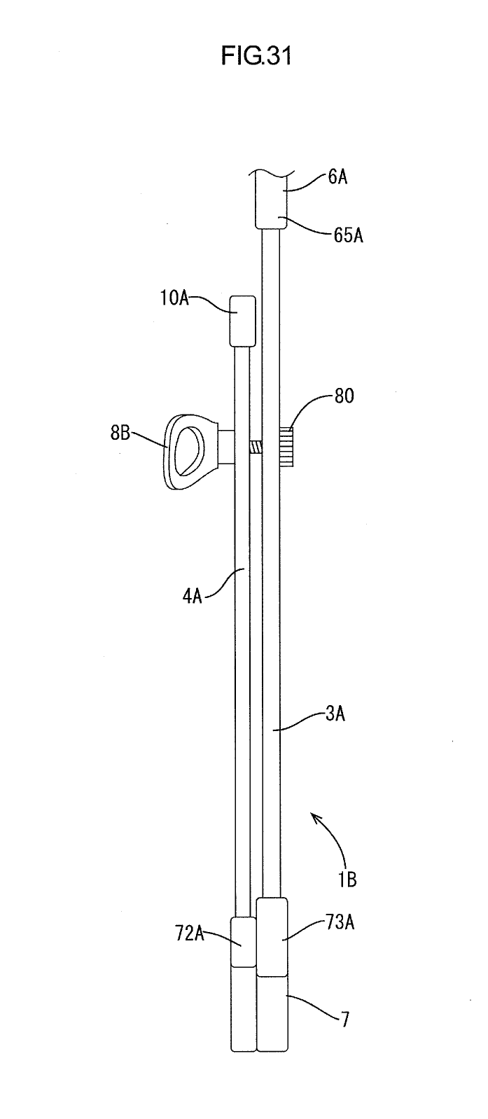

(14) FIG. 31 is a rear view of a walking assistance device 1B of another different embodiment. The walking assistance device 1B includes the thigh link portion 3A and the lower leg link portion 4B that are same as those of the walking assistance device 1A of the fifth embodiment. The walking assistance device 1B includes the waist joint portion 6A and the knee joint portion 7A that are same as those in the fifth embodiment. The lower leg link portion 4A of the walking assistance device 1B does not include the lower leg wearing portion. The lower leg link portion 4A is overlapped with the thigh link portion 3A in the right-left direction in FIG. 31 such that the protection cap 10A protecting the lower end of the lower leg link portion 4A faces upward. The thigh contact portion 8B is mounted on an inner side of the lower leg link portion 4A (facing the user's thigh). The thigh contact portion 8B is fixed to the lower leg link portion 4A and the thigh link portion 3A with using a screw-shaped fixing member 80. A belt (not illustrated) may be hooked on the thigh contact portion 8B to put around the user's thigh and fix the link portions. Thus, the walking assistance device 1B including the lower leg link portion 4A and the thigh link portion 3A that are overlapped with each other may be used.

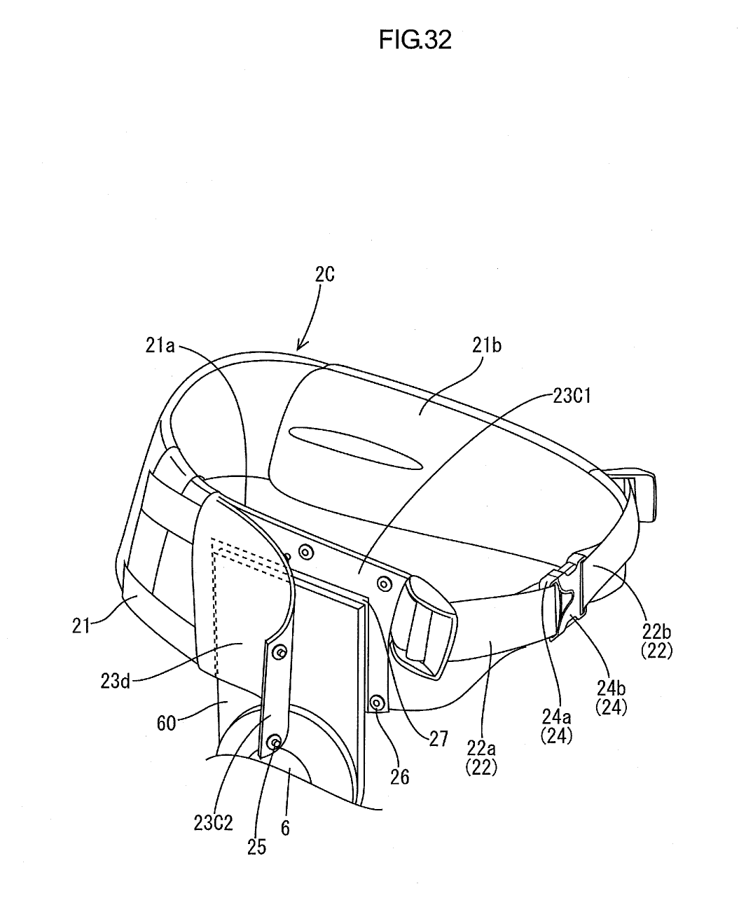

(15) FIG. 32 is a perspective view of a waist wearing belt 2C of another different modification. The basic configuration of the waist wearing belt 2C is same as that in the first embodiment. The waist wearing belt 2C includes a receiver portion 23C that differs from the bag-shaped one in the first embodiment and is an open-close type. Specifically, the receiver portion 23C includes a receiver main body portion 23C1 and a receiver cover portion 23C2. The receiver main body portion 23C1 is put on a rear side surface of the mount plate 60 of the waist joint portion 6. The receiver cover portion 23C2 covers a front side surface of the mount plate 60. A rear end portion of the receiver cover portion 23C2 is integrally connected to the receiver main body portion 23C1. A front end portion of the receiver cover portion 23C2 is removable from the receiver main body portion 23C1. The receiver cover portion 23C2 has a plurality of projected fitting portions 25 and the receiver main body portion 23C1 has a plurality of recess fitting portions 26 that are fitted to the fitting portions 25 to be fixed thereto. The receiver cover portion 23C2 is attached to the receiver main body portion 23C1 by the fitting of the fitting portions 25 and the fitting portions 26. The receiver cover portion 23C2 is detached from the receiver main body portion 23C1 by releasing the fitting. A hook-and-loop fastener portion 27 is attached to a surface of the receiver main body portion 23C1 and the hook-and-loop fastener portion 27 is adhered to another hook-and-loop fastener portion attached to the mount plate 60. The receiver portion 23C of the waist wearing belt 2C is the open-close type as described before. Therefore, the mount plate 60 is mounted on the receiver portion 27C (the hook-and-loop fastener portion 27) with the receiver cover portion 23C2 being open. Also, the mount plate 60 is detached from the receiver portion 27C (the hook-and-loop fastener portion 27) with the receiver cover portion 23C2 being open. Therefore, the mount plate 60 is easily mounted on and removed from the waist wearing belt 2C.

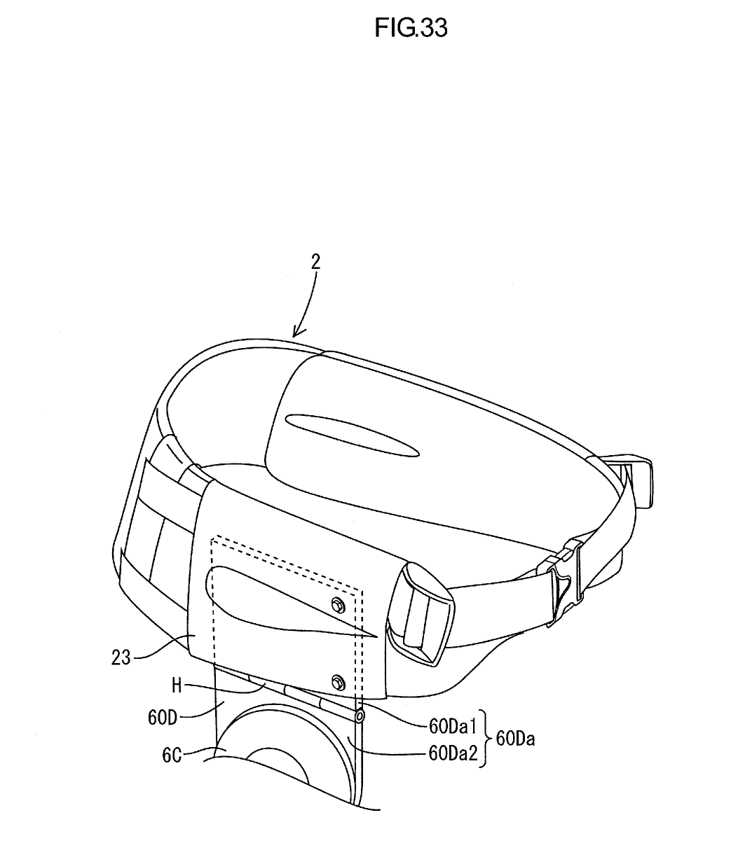

(16) FIG. 33 is a perspective view of a mount plate 60D according to another different modification. The mount plate 60D is mounted on the waist wearing belt 2 similarly to the first embodiment. Unlike the first embodiment, the mount plate 60D includes a plate-like main body 60Da including an upper main body portion 60Da1 and a lower main body portion 60Da2. The upper main body portion 60Da1 and the lower main body portion 60Da2 are connected to each other via a hinge portion H. The hinge portion H is located in a portion of the main body portion 60Da between the waist joint portion 6 and the receiver portion 23 of the waist wearing belt 2. The mount plate 60D is folded at the hinge portion H so that the hinge portion H is moved outwardly and the upper main body portion 60Da1 and the lower main body portion 60Da2 approach each other. Provided with such a hinge portion H, the mount plate 60D is folded to fit to the shape of the user's waist side portion. As a result, the mount angles of the thigh link portion and the lower leg portion of the walking assistance device with respect to the lower leg are adjusted.

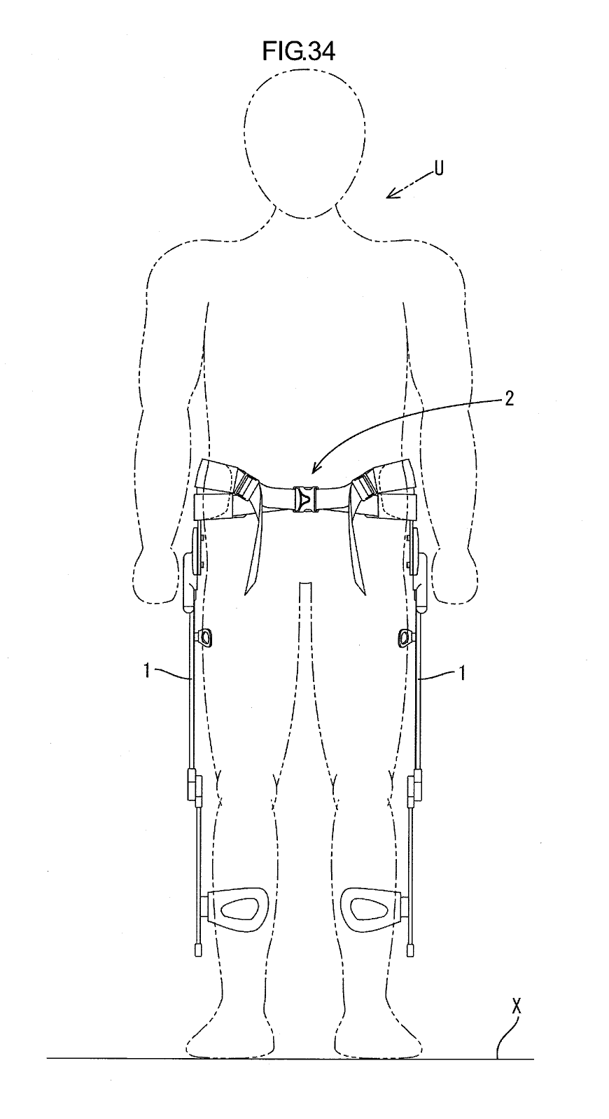

(17) FIG. 34 is a view illustrating the walking assistance devices 1 each of which is put on each leg. As illustrated in FIG. 34, the walking assistance device 1 may be put on each of the user's two legs. The walking assistance device 1 for a right leg and that for a left leg have symmetric configurations and basically have a same configuration. With the walking assistance devices 1 put on the respective two legs, the walking action of the user U is supported and improved (corrected).

### EXPLANATION OF SYMBOLS

1: walking assistance device, 2: waist wearing belt, 21a: pad portion, 3: thigh link portion, 3a: upper end portion, 3b: lower end portion, 4: lower leg link portion, 4a: upper end portion, 4b: lower end portion, 5: lower leg wearing portion, 6: waist joint portion, 61: waist shaft, 7: knee joint portion, 71: knee shaft, 8: thigh contact portion, 9: torque generator, U: user (wearer), U1: right leg (affected leg), U11: thigh, U12: lower leg, U2: left leg (normal leg), U3: waist, U31: right waist side portion

1: A walking assistance device to be put on a leg of a user to assist walking of the user, the walking assistance device comprising:
a waist wearing belt including a pad member to be put on a waist side portion of the user, the waist wearing belt to be put around a waist of the user;
a thigh link portion having an elongated shape and to be arranged on a side of a thigh of the user;
a lower leg link portion having an elongated shape and to be arranged on a side of a lower leg of the user;
a lower leg wearing portion to be put on a lower leg of the user and mounted on the lower leg link portion;
a waist joint portion configured to hold an upper end portion of the thigh link portion so that the thigh link portion swings in a front-rear direction of the user, the waist joint portion being mounted on the pad member of the waist wearing belt; and
a knee joint portion configured to hold a lower end portion of the thigh link portion and an upper end portion of the lower leg link portion and configured to connect the thigh link portion and the lower leg link portion so that the thigh link portion and the lower leg link portion swing, respectively, wherein
the thigh link portion and the lower leg link portion have rigidity that is greater in the front-rear direction and an up-down direction than in a right-left direction so as to be elastically twisted around an axis along an elongated direction of the thigh link portion and the lower leg link portion.

2: The walking assistance device according to claim 1, wherein
each of the thigh link portion and the lower ling portion includes
a pair of tubular portions and a plate-like connection portion, the pair of tubular portions are arranged parallel to each other with having a distance therebetween and each of the tubular portions has a space therein, and the connection portion is provided between the tubular portions to connect the tubular portions.

3: The walking assistance device according to claim 1, wherein
the thigh link portion and the lower leg link portion are extendable in the elongated direction.

4: The walking assistance device according to claim 1, wherein
the waist joint portion holds the upper end portion of the thigh link portion so as to be removed therefrom, and
the knee joint portion holds the lower end portion of the thigh link portion and the upper end portion of the lower leg link portion so as to be removed therefrom.

5: The walking assistance device according to claim 1, wherein
the thigh link portion is selected from a thigh link portion group including a plurality kinds of thigh link portions having different conditions such as various elongated lengths, and
the lower leg link portion is selected from a lower leg link portion group including a plurality kinds of lower leg link portions having different conditions such as various elongated lengths.

6: The walking assistance device according to claim 1, wherein the lower leg wearing portion is selected from a lower leg wearing portion group including plurality kinds of lower link wearing portions having different conditions such as various circumferential lengths.

7: The walking assistance device according to claim 1, further comprising a weight that is detachably mounted on the thigh link portion and/or the lower leg link portion.

8: The walking assistance device according to claim 7, wherein the weight is selected from a group of various kinds of weights having various weights.

9: The walking assistance device according to claim 1, wherein
each of the thigh link portion and the lower leg link portion includes a pair of elongated plate-like processed components that are connected together to be opposed to each other.

10: The walking assistance device according to claim 1, wherein
the waist joint portion includes:
a waist shaft;
a holder where one end of the waist shaft is fixed and that holds the upper end portion of the thigh link portion;
a main body portion connected to the holder and configured to swing the thigh link portion around the waist shaft in a front-rear direction;
a rotary plate supported on the waist shaft to be rotatable around the waist shaft and fixed to the main body portion; and
a mount plate fixed to the rotary plate to be rotatable with the rotary plate and mounted on the waist wearing belt via the pad member, and the walking assistance device further comprising:
a torque generator including:
a compression spring;
a determination portion being in contact with one end of the compression spring and configured to determine a position of the one end;
a displacement portion being in contact with another end of the compression spring and configured to displace according to expansion and contraction of the compression spring;
a cam follower connected to the displacement portion; and
a cam portion having an outer surface configured to push the cam follower to compress the compression spring and having distances from the waist shaft so as to change along a circumferential direction, the cam portion included on a peripheral edge portion of the rotary plate.

11: The walking assistance device according to claim 1, wherein
each of the thigh link portion and the lower leg link portion is configured to be elastically twisted around a shaft along the elongated direction within an angle range of from +70° to −70°.
